(19) United States
(12) Patent Application Publication
(10) Pub. No.: US 2025/0326484 A1
(43) Pub. Date: Oct. 23, 2025

(54) PROPULSION UNIT FOR AN AIRCRAFT

(71) Applicant: SAFRAN AIRCRAFT ENGINES, Paris (FR)

(72) Inventors: Fernando GEA AGUILERA, MOISSY-CRAMAYEL (FR); Anthony BINDER, MOISSY-CRAMAYEL (FR); Adrien Clément Marcel DUBOIS, MOISSY-CRAMAYEL (FR); Mathieu Simon Paul GRUBER, MOISSY-CRAMAYEL (FR); Vincent JOUDON, MOISSY-CRAMAYEL (FR)

(21) Appl. No.: 18/293,218

(22) PCT Filed: Jul. 28, 2022
(86) PCT No.: PCT/FR2022/051521

§ 371 Date: Dec. 17, 2024

(30) Foreign Application Priority Data
Jul. 29, 2021 (FR) 2108287

(51) Int. Cl. B64C 11/30; B64C 11/48; F01D 5/14

(52) U.S. Cl. CPC B64C 11/30; B64C 11/48; F01D 5/14; F05D 2240/303; F05D 2240/304

(57) ABSTRACT

An aeronautical propulsion unit includes a central engine, an upstream series and a downstream series of blades, the blades of at least one of these series being adapted to be driven in rotation about the central longitudinal axis by a turbine, and a nacelle which encloses the central engine. At least some of the blades of the two series are variable-pitch blades. At least one of the blade of the first series of blades has a trailing edge having serrations, and/or at least one of the blades of the second series of blades has a leading edge having serrations.

### CROSS-REFERENCE TO RELATED APPLICATIONS

This application is a US National phase Application of PCT/FR2022/051521 filed Jul. 28, 2022, which claims priority to French Patent Application No. 2108287 filed Jul. 29, 2021, both of which are hereby incorporated in their entirety.

### BACKGROUND

The invention relates to an aeronautical propulsion unit, in particular for an airplane, along which a gas flow can circulate from upstream to downstream, the propulsion unit having a central longitudinal axis (X), and comprising:
a first series of blades,
a second series of blades positioned downstream of the first series of blades, the first and second series of blades each defining an unducted blade assembly, including at least one open rotor (also known as an unducted fan) which can be rotated,
(at least) one engine (which can be called the central engine), for driving said rotation around the central longitudinal axis of the blades of at least one of the first series of blades and the second series of blades, and
a nacelle which can contain the engine.

The expression “unducted” therefore corresponds to “open” (as in “open rotor”) as well as to “unducted” (as in “unducted fan”).

Hereinafter the terms blade and vane designate the same thing.

The engine may be a heat engine, in particular a turboshaft engine, a turbojet engine, a low-bypass ratio turbofan engine, a high-bypass ratio turbofan engine, a turbofan engine with gears or with a speed reduction gearbox, a turbojet engine with contra-rotating turbines, an electric motor, a hydrogen combustion engine, or a hybrid engine: thermal and/or electric and/or hydrogen.

Of course, the use of several engines is not excluded.

Energy source(s) for the engine(s) include kerosene fuels, aviation gasoline, diesel, aviation biofuels, electricity, and hydrogen.

The invention is therefore applicable in particular to:
turbomachines of the open rotor type (for example, a Contra-Rotating Open Rotor, CROR) and open rotor-stator type (for example, a USF: unducted single fan or rotor followed by a swirl recovery stator), hereinafter “open rotor(s)” or “unducted rotor and stator” forming a system of blade assemblies,
turbomachines which can be a turboprop engine, but which alternatively can be a turbojet with a contra-rotating fan or with an unducted rotor and stator pair.

One will recall that in aeronautics, a turbomachine is a propulsion unit based on gas turbine(s).

Particularly among gas turbine engines, some are known that use an architecture of the open rotor(s) or unducted rotor and stator type.

For example, a single-flow turbojet engine operates on the principle that a gas turbine engine drives a fan, with the fan positioned at a radial location between a nacelle of the engine and the engine hub.

An engine with open rotor(s) or with an unducted rotor and stator operates differently, with the fan located outside the nacelle of the central engine, radially to the axis of rotation of the central engine. This allows using fan (or propeller) blades which can be larger and capable of acting on a greater volume of air than for a ducted dual-flow turbojet engine. The bypass ratio (BPR) and the propulsion efficiency can thus be improved in comparison to conventional engines.

In a gas turbine engine or a multiple gas turbines engine, the invention detailed below applies here whether said open rotor(s) or unducted rotor and stator are arranged upstream of the combustion chamber (“puller” configuration) or downstream of it (“pusher” configuration).

In a puller configuration, at least the first series of blades:
is driven to rotate about the central longitudinal axis, and
is located at the compressor(s) of the engine and/or the speed reduction gearbox, if there is such and if the engine is a gas turbine engine or a multiple gas turbines engine.

In a pusher configuration, at least the first series of blades:
is driven to rotate about the central longitudinal axis, and
is located at the turbine(s) of the engine if the engine is a gas turbine engine or a multiple gas turbines engine.

In each of these two cases, within the system of one or more blade assemblies, it is conceivable to place the power turbine of the central engine, which drives the rotor(s), upstream or downstream or at these contra-rotating blade assemblies or at a paired rotor blade assembly/swirl recovery stator.

This is also applicable for the position of a speed reduction gearbox (for example, a differential planetary gearbox, as disclosed in EP2521851) in the case of a central engine with a gear system opposite to the rotor blade assembly or assemblies.

Indeed, in a gas turbine (or a multiple gas turbines) engine, particularly in the case of a CROR, it can be highly relevant to interpose a speed reduction gearbox between the blades concerned and the (or one of the multiple) turbine(s), so that the blades of the upstream and/or downstream blade assembly in question rotate at a lower speed compared to the (or one of the multiple) turbine(s).

This is also applicable for the position of the planetary gear in the case of a turboprop engine (with planetary gear) opposite to the rotor blade assembly or assemblies.

Thus, in the field, an aeronautical propulsion unit is known along which a gas flow can circulate from upstream to downstream, the propulsion unit having a central longitudinal axis (X), and comprising:
a first series of blades,
a second series of blades positioned downstream from the first series of blades,
drive means (hereinafter sometimes referred to as first drive means) for rotating the blades of at least one among the first series of blades and second series of blades, about the central longitudinal axis,
a nacelle which has an aerodynamic external surface relative to which the first series of blades and the second series of blades project, radially to the central longitudinal axis, each blade of the first series of blades and second series of blades having:
   a free end opposite to a connection end forming a blade root close to the nacelle,
   a pressure side (“intrados”) face and a suction side (“extrados”) face,
   a chord line C located at a defined radius centered on the central longitudinal axis,
   a radius Ri between the central longitudinal axis and a location which is level with the external surface of the nacelle, this location being situated:
      on the blade or
      on a pitch arm of the blade,
   a radius Re between the central longitudinal axis and a location, on the free end of the blade, that is farthest from the central longitudinal axis X, in a direction transverse to the central axis, and
   a span (distance Re-Ri) defined, radially to the central longitudinal axis, between the free end and the connection end, in said transverse direction,
   at least some of the blades of the first series of blades having a variable pitch (angle), such that each of them can pivot around a pitch arm to which said blade is fixed, about a pitch axis which passes through the blade, and/or
   at least some of the blades of the second series of blades also having a variable pitch (angle), so that each of them can pivot about said pitch arm to which said blade is fixed, around a pitch axis that passes through the blade.

The first series of blades and the second series of blades (or first blade assembly and second blade assembly) are therefore axially spaced apart from one another.

It is understood above that an aeronautical propulsion unit is an energy generating device which, in the field of air navigation, provides the movement of a movable body and/or the operation of an engine.—It will also be noted that when “radial(ly)” expresses an orientation (such as those of the two series of blades), this term more generally covers any direction oriented so as to intersect (skewed) the reference axis, in this case the X axis; strict perpendicularity is therefore not required—.

In fact, there are already known gas turbine aeronautical propulsion units (where the engine is often called the “core engine”) which comprise drive means for rotating the blade concerned via the pitch arm to which it is fixed, around its pitch axis.

In a manner known in other applications, this involves a pitch change mechanism (PCM) connected to the pitch arm of the blade at the base of the blade.

One problem encountered still concerns the noise generated by the propulsion unit.

Mechanical strength, efficiency, and aerodynamic performance can also be concerned, as well as other aspects mentioned below.

By improving efficiency and/or aerodynamic performance, an impact in the fight against global warming is also an aim.

### SUMMARY

The invention aims to respond to some or all of these problems in a simple, reliable, and inexpensive manner.

To this end, the invention therefore relates to an aeronautical propulsion unit in accordance with the above, with a first and second series of unducted blades (CROR/USF type for example) and which therefore comprises in particular:
a so-called first series of blades, and a so-called second series of blades positioned downstream of the first series of blades,
first drive means for rotating the first series of blades and/or the second series of blades around the central longitudinal axis,
second drive means for rotating at least one of said blades via its pitch arm to which the blade is fixed, around its pitch axis, so that:
   at least some of the blades of the first series of blades have variable pitch, and/or
   at least some of the blades of the second series of blades have variable pitch.

In addition to the above, in this aeronautical propulsion unit it will be provided that:
at least one of the blades of the first series of blades has a trailing edge (sometimes referred to hereinafter as TE) having serrations, and/or
at least one of the blades of the second series of blades has a leading edge (sometimes referred to hereinafter as LE) having serrations, said serrations having tooth tips and tooth troughs which successively alternate and/or:
at least some of said blades of the first series of blades and/or of the second series of blades each have, along the span (L) of the blade or radially to the central longitudinal axis (X), a pitch angle variation (Δγ) that is less than 45°, between:
   a first straight line connecting the leading edge and the trailing edge, at a first radius where one of said tooth tips is located, and
   a second straight line connecting the leading edge and the trailing edge, at a second radius where one of said tooth troughs is located, adjacent to said one of the tips.

One can exclude the lower limit 0° and impose a minimum angle Δγ (in absolute value) of 0.25°, preferably 0.5°. One can even give preference to a preferred variation range Δγ between two successive tips, two successive troughs, or between a successive tip and trough, such as 0.25°≤Δγ≤25°, and even more strictly such as 0.5°≤Δγ≤15° (still in absolute value).

The same goes for the variation in skeleton angle (Δβ1) at the leading edge or (Δβ2) at the trailing edge, again between two successive tooth tips, two successive troughs, or between a successive tip and trough.

The angles beta1 (β1), beta 2 (β2), and pitch angle (γ) then make it possible, in particular with these values, to more finely control the velocity triangle for the flow, i.e. the incidence of the flow at the LE or the exit angle of the flow at the TE as a function of the radial position. For a turbomachine blade, it is necessary to vary these angles according to the radial position (or span) in order to optimize its aerodynamic operation as a function of the rotation speed and forward speed. This is all the more important when there are serrations present at the LE and/or TE.

The presence of serrations at the LE then directs and accelerates the flow all the more towards the troughs, which can be exposed to excess speed and overincidence and therefore a lift loss phenomenon. It is therefore important to ensure that the angle beta1 between a tip and a trough that are adjacent to one another, are different. The same reasoning is valid for the pitch angle.

The presence of serrations at the TE creates cross-flow and/or horseshoe-shaped vortices between two adjacent tooth tips. This is due to the excess pressure at the pressure side which directs the flow towards the suction (lower pressure) side. This cross-flow increases aerodynamic losses and can be disadvantageous for acoustics (because the wakes are higher in energy and can interact with downstream elements such as a stator and/or a wing). This phenomenon can be reduced by ensuring that angle beta2 between a profile containing a tip and a profile containing a trough, which are adjacent to one another, are different. The same reasoning is valid for the pitch angle.

In principle, any serration will include the alternating succession of at least two tooth tips and two troughs (or valleys).

The terms axial, radial, and circumferential are defined in relation to the X axis of the propulsion unit.

Each pitch arm is the arm which rotates around an axis (the pitch axis) extending (possibly radially) cross-wise relative to the central longitudinal axis and around which the blade, attached to this arm, pivots in order to change the angle of attack of the flow of gas which passes through the rotor blade assembly or the stator concerned.

Each pitch axis can pass through a blade and a pitch arm.

Furthermore, the terms upstream (UPSTR) and downstream (DWNSTR) are defined in relation to the direction in which gases circulate in the propulsion unit.

The first drive means may comprise, placed in the nacelle, an engine which drives the rotation of the first series of blades and/or the second series of blades about the central longitudinal axis. A gas turbine engine is concerned in particular. But, as already mentioned, the engine can be thermal (such as a turboshaft engine, turbojet engine, turbofan engine), electric, hydrogen, or hybrid (in particular thermal and/or electric and/or hydrogen-based).

Said engine driving the rotation can therefore comprise at least one compressor, a combustion chamber, and at least one gas turbine, and thus be of the aeronautical turbomachine type.

There may be provided:
a rotary speed reducer for the first series of blades and/or the second series of blades, for reducing speed about the central longitudinal axis; and/or
a configuration that is both pusher and puller, particularly in the USF configuration.

Transmission members are typically interposed between this engine driving the rotation and the blades.

Arranged in the nacelle, said engine driving the rotation, and possibly the transmission members, will then be enclosed in the nacelle.

Other features that may complement the basic solution above are presented below.

Some are included in this “Presentation of the invention” section, others only in the “Detailed description of the invention”, in order to avoid repetition.

As additional features, one can already note that, for the (first) means for driving the rotation of the blades, of at least one among the first series of blades and the second series of blades, about the central longitudinal axis:
they may comprise a gas turbine (in other words a gas turbine engine or a multiple gas turbines engine), and/or
these (first) drive means, or this engine, may comprise a speed reducer engaged with the blades of at least one among the first series of blades and the second series of blades, in order to adapt the rotation speed of said blades around the central longitudinal axis (X).

On this subject, note that on such a turbine (or multi-turbine or multiple turbines) engine, the speed reducer would be placed between the (or one of the multiple) turbine(s) driving the blades of the first series of blades or the second series of blades (or the rotation drive shaft of the turbine considered) and the blades of the blade assembly concerned, in order to reduce their rotation speed.

A double turbine, axially high pressure then low pressure, could in particular be used.

In the case of a gas turbine (or a multiple gas turbines) engine, traditionally and successively one will find, along the X axis, one or more compressors, one or more combustion chambers, one or more turbines for driving the compressor(s) via one or more axial drive shafts, and one or more gas exhaust nozzles.

In connection with all of the above, and in particular the case where the blades of the first series of blades are rotated by said drive turbine via a speed reducer, a case of particular interest could be the one where the pair of upstream/downstream blade assemblies is in a puller configuration: pair of blade assemblies located towards the upstream end of the central engine nacelle, upstream of the combustion chamber, whether in a blade assembly configuration with paired rotor/stator (upstream rotor and downstream stator) or rotor/rotor (upstream rotor and downstream rotor).

One of the benefits of a speed reducer between the turbine(s) and the open rotor(s) is to improve performance and therefore optimize the operation of each module of the aeronautical propulsion unit. Furthermore, a puller configuration is compatible with both an under-wing installation of the aeronautical propulsion unit (as in most commercial aircraft) or at the rear of the aircraft using a mast or pylon.

It could be of interest for:
the blades of the first series of blades and the second series of blades to be arranged to be rotatable about the central longitudinal axis (X) by the turbine(s) concerned, and
the turbine concerned to be adapted to drive, around the central longitudinal axis (X), the first series of blades at a rotation speed that is greater than or equal to the rotation speed of the second series of blades.

Concerning the blades, one may also note the following characteristics a), b), etc., which are to be considered independently or in a combination of some or all of them:
a) the first series of blades and the second series of blades can have different numbers of blades; This makes it possible to reduce noise because it prevents having all the wakes of the upstream blade assembly (rotor) from simultaneously impacting the downstream blade assembly (rotor or stator) and therefore allows decorrelating the acoustic radiation from the blades;
b) it may be provided that:
   each blade of the first series of blades and/or of the second series of blades has a maximum thickness between the pressure side face and the suction side face, and
   on the blades, the maximum thickness of the blades (or between the pressure side and suction side profiles which define the blade concerned) is located near the blade root, at a distance of less than 0.1×(Re-Ri) from the connection end (often referred to as the blade root); this helps to improve the mechanical strength of the blades during nominal operation, as well as in the event of bird intake. The mechanical forces on blades having LE/TE serrations could be greater than the nominal case with smooth LE/TE. In such case, this feature would be necessary in order to improve the mechanical strength of the blades having serrations; A minimum value for the thickness of the blade at the fixed end will then have been given preference, dictated by mechanical reasons more than by aero-acoustic reasons;
c) each blade of the first series of blades and/or of the second series of blades has a hub-to-free-end ratio Ri/Re such that Ri/Re is between 0.10 and 0.50; A hub ratio which varies within this range guarantees a good compromise between aerodynamic requirements (large blades therefore a low Ri/Re) and the requirements for integrating systems into the hub (PCM, oil pipes, etc., hence a large Ri/Re);
d) it may be provided that:
   the blades of the first series of blades and/or of the second series of blades are located on a closed line centered on the central longitudinal axis and having a diameter D,
   the pitch axes or the pitch arms of the blades of the first series of blades and of the second series of blades are axially separated, pairwise, by a distance S, and
   the S/D ratio is between 0.005 and 1, and preferably between 0.15 and 0.70; Increasing the axial spacing between the upstream and downstream blade assemblies (rotor or stator) makes it possible to reduce noise in most cases, due to dissipation of the turbulent wake of the upstream blade assembly during its propagation downstream. Thus, the wakes which arrive at the leading edge of the downstream blade assembly (rotor or stator) are less energetic; but increasing this distance too much between the blade assemblies could pose problems of mass (turbomachine longer in the axial direction) and of more complex integration of the turbomachine into the aircraft. Furthermore, the trailing edge of each of the blades of the first series of blades is located longitudinally upstream of a leading edge of each of the blades of the second series of blades. This avoids interference between the series of blades.
e) clipping could be profitable, meaning a situation where the span L (or Re-Ri) of the blades of the upstream blade assembly (rotor) is greater than that of the blades of the downstream blade assembly (rotor or stator), this distance being measured here along the pitch axis. Clipping (as in FIG. 4 below) helps reduce noise, because by reducing the span of the downstream blade assembly (rotor or stator), one can avoid the impact of the upstream blade assembly's (rotor) blade tip vortex, which is very high in energy. From an aerodynamic point of view, clipping can have a negative impact, however, because part of the gyration of the flow produced by the upstream blade assembly is not recovered by the downstream blade assembly, particularly the upper portion.

In other words, it may then be provided that:
the blades of the first series of blades are arranged to be able to be rotated about the central longitudinal axis by said drive turbine of the aforementioned series or two series of blades, and
the distance Re-Ri, measured from the connection end, of the blades of the first series of blades is greater than that of at least one of the blades of the second series of blades.
f) the maximum diameter (2×Re) of the blade assembly (upstream or downstream) is between 1 m and 6 m.

In other words, the diameter of the blades of the first series of blades and of the blades of the second series of blades will then be respectively inscribed in a first circle and a second circle, each having a circumference between 1 m and 6 m.

As above, this is a compromise to be reached, in particular in relation to solidity, weight, and noise.

Note also that, on a leading edge area or trailing edge area having serrations, a variation in skeleton angle (Δβ1 below) at the leading edge or (Δβ2 below) at the trailing edge, between a tooth tip and a tooth trough (or valley) that are adjacent to one another, along the span of a blade, or radially to the central longitudinal axis (X), may beneficially be greater than 0° and less than 45°, or in some cases even 30°. This avoids cases of isolated serrated profiles. Indeed, it has been found that:
the angle of attack of the air as perceived by the blade profile(s) at the troughs and tips of the LE serrations is then suitable, and/or
there are no lift loss phenomena impacting the performance of the blade(s).

Other considerations of a comparable nature may usefully be given priority, namely at least one of the following seven considerations:
g) a variation in blade pitch angle (Δγ) between a profile containing a tooth tip and a profile containing a tooth trough, adjacent to one another,
   along the span (L) of the blade, or
   radially to the central longitudinal axis (X),
is less than 45°, and preferably greater than 0°; and/or
h) a variation in blade pitch angle (Δγ) between two profiles containing tooth tips and/or between two profiles containing tooth troughs, respectively adjacent to one another (from tip to trough and/or from trough to tip, in a given direction along the serrations),
   along the span (L) of the blade, or
   radially to the central longitudinal axis (X),
is less than 45°, and preferably greater than 0°; and/or
i) on a leading edge area or trailing edge area of a blade having serrations, a variation in skeleton angle (Δβ1) at the leading edge or (Δβ2) at the trailing edge, between two tooth tips and/or two tooth troughs, respectively adjacent to one another,
   along the span (L) of the blade, or
   radially to the central longitudinal axis (X),
is less than 45°, and preferably greater than 0°; and/or
j) on a leading edge area or trailing edge area of a blade having serrations, a variation in skeleton angle (Δβ1) at the leading edge or (Δβ2) at the trailing edge, between two adjacent profiles containing tooth tips and/or between two profiles containing tooth troughs, adjacent to one another,
   along the span (L) of the blade, or
   radially to the central longitudinal axis (X),
is less than 45°, and preferably greater than 0; and/or
k) at least one of the blades of one of the blade assemblies (i.e. series of blades) has the greatest deflection at a radial position located over a radial length of 0.4×(Re-Ri) from said free end of the blade considered (this consideration is preferably for the blades of the upstream blade assembly, but it would also be valid for the blades of the downstream blade assembly); and/or
l) at least one of the blades of the downstream series of blades (i.e. second series of blades) has a radius Re that is larger at the leading edge than at the trailing edge, when the leading edge and trailing edge lines are not coincident, and/or at least one of the blades of the first series of blades has a radius Re that is smaller (preferably) or larger at the leading edge than at the trailing edge, when the leading edge and trailing edge lines are not coincident.

One will further note that the following is of interest, in relation to an acoustic aspect and/or blade span aspect, in particular that of the downstream blade assembly (as explained in more detail later on in this text):
m)—the nacelle will have an air inlet, this air usefully being intended for the engine and defining (at least part) of the primary air flow supplying this engine, if it is a gas turbomachine, and
   on the nacelle, said air inlet will then be located axially between the pitch axes of the blades of the first series of blades and of the second series of blades; or possibly even:
n) on the nacelle, the air inlet will have a lip located at a radius “Rb” from the central longitudinal axis (X), and said trailing edge serrations of the first series of blades will then be located at said radius Rb.

Particularly in case m), it is thus that the (or an) air inlet can usefully be defined on the circumferential wall of the nacelle, downstream of the first series of blades, said air inlet therefore able, in the case of a turbomachine, to traverse the turbine and serve as the primary air inlet for such an engine.

### BRIEF DESCRIPTION OF FIGURES

FIG. 1 illustrates an aircraft powered by unducted fan engines which can make use of the invention,

FIG. 2 illustrates a direct-drive turbine system that can drive the blade assemblies of FIG. 1,

FIG. 3 illustrates a polygonal ring which surrounds a turbine stage and supports the blades of the blade assembly (or rotor), in conjunction with FIG. 2,

FIG. 4 is a side view of part of a propulsion unit of the invention, according to one embodiment,

FIG. 5 is a side view of part of a propulsion unit of the invention, according to another embodiment,

FIG. 6 is a side view of part of a propulsion unit of the invention, according to another embodiment, but with the air inlet for the primary flow located between the upstream blade assembly and the downstream blade assembly, as in the embodiment of FIG. 5,

FIG. 7 is a side view of a part of a propulsion unit of the invention, according to another embodiment,

FIG. 8 is a schematic view of part of a blade root and its environment, in accordance with one possible embodiment, in the case of a variable-pitch stator blade, seen in a section view parallel to the axis of the engine mounted in the nacelle, specifically in the nacelle casing,

FIG. 9 is a section view of a blade of the invention, according to one possible embodiment,

FIG. 10 schematically illustrates a front view of one possible configuration of certain stator blades,

FIG. 11 schematically illustrates one possible evolution of several sources of noise on an SPL (“Sound Pressure Level”) sound spectrum (in dB) as a function of the frequency f (in Hz), for a CROR configuration, therefore with two contra-rotating blade assemblies, respectively upstream and downstream,

FIG. 12 schematically illustrates one possible evolution of several noise sources in an SPL (“Sound Pressure Level”) sound spectrum (in dB) as a function of frequency (in Hz), for a USF configuration, therefore with an upstream rotor blade assembly and a downstream stator blade assembly,

FIG. 13 FIG. 14 FIG. 15 FIG. 16 FIG. 17 FIG. 18 FIG. 19 FIG. 20 FIG. 21 FIG. 22 FIG. 23 FIG. 24 FIG. 25 FIG. 26 schematically show side views of a blade of the invention, according to several possible embodiments,

FIG. 27 and FIG. 28 schematically illustrate a side view of a local external surface of the blade (with TE or LE) of the invention, according to two possible forms of serrations and of embodiments of the body of the blade (with the presence of areas of acoustically damping foam or porous surface),

FIG. 29 is a side view of part of a propulsion unit of the invention, according to another embodiment,

FIG. 30 illustrates a schematic longitudinal cross-section through a dual-flow contra-rotating blade assembly of a gas turbine engine which makes use of the invention,

FIG. 31 illustrates an enlarged view of a system of contra-rotating blade assemblies equipping a turbomachine using the invention,

FIG. 32 illustrates cross-section AA′ of FIG. 7,

FIG. 33 illustrates cross-section BB′ of FIG. 7,

FIG. 34 and FIG. 35 illustrate the characteristic angles of a profile (FIG. 35 corresponds to cross-section CC′ or DD′ of FIG. 34),

FIG. 36 and FIG. 37 illustrate other blade configuration variations, and

FIG. 38 illustrates serrations at the TE, on the span,

FIG. 39 illustrates an example showing Δγ between a tip and a trough of teeth that are adjacent to one another,

FIG. 40 illustrates an example showing Δγ between two successive tooth tips,

FIG. 41 illustrates an example showing Δγ between two successive tooth troughs,

FIG. 42 illustrates an example of a variation in skeleton angle (Δβ1) at the leading edge, between a tip and a trough of successive teeth, therefore adjacent to one another; but this could be two successive tooth tips or two successive tooth troughs,

the same being true for FIG. 43, but with the skeleton angle (Δβ2) at the trailing edge.

### DETAILED DESCRIPTION OF THE INVENTION

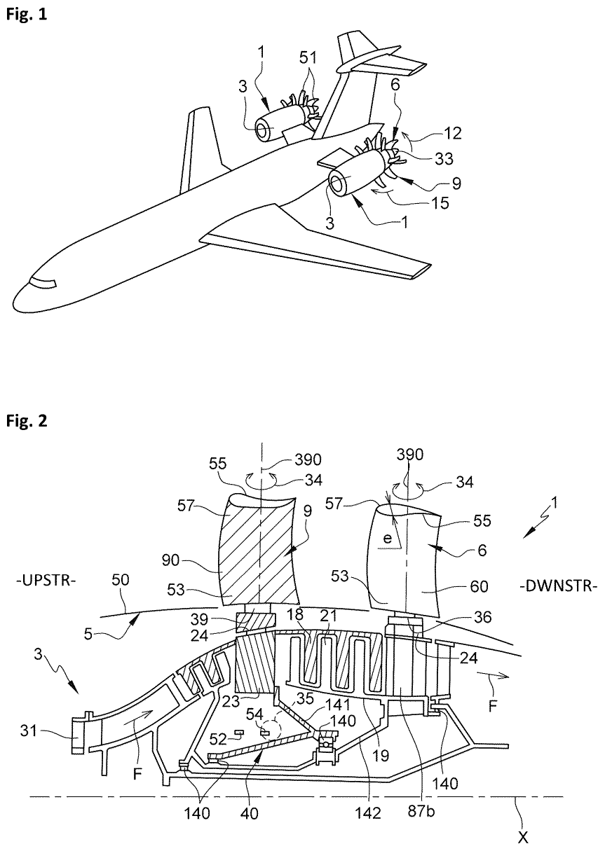

In particular, FIGS. 1 and 2 schematically illustrate an aeronautical propulsion unit 1, in particular an aircraft single-flow turbojet engine with open rotors, according to one embodiment of the invention. Propulsion unit 1 extends along an X axis.

In the following, when the propulsion means of propulsion unit 1 are mentioned, reference is made to a turbomachine, therefore to a gas turbine (or a multiple gas turbines) propulsion unit.

However, this should not be considered limiting, as has already been mentioned.

Thus, FIG. 1 illustrates an aircraft powered by at least one (for example two) aeronautical propulsion unit 1, the or each aeronautical propulsion unit 1 comprising:
an engine 3, which can be called the central engine, having a central longitudinal axis X (which may be parallel to the longitudinal axis of the aircraft), along which a gas flow can circulate from upstream (UPSTR) to downstream (DWNSTR),
a first series of blades 9, which can be considered as defining a blade assembly,
a second series of blades 6 positioned downstream of the first series of blades and which can also be considered as defining a blade assembly.

Note that the parallelism between the central longitudinal axis X and the longitudinal axis of the aircraft is not a necessary condition for implementing the invention. The central axis of the turbomachine can have a non-zero angle relative to the axis of the aircraft (“cant angle”) in order to minimize the effects of installation.

Central engine 3 is enclosed in nacelle 5 which surrounds it circumferentially.

In accordance with a CROR configuration, blade assemblies 6 and 9 are, in the example of FIG. 2, both rotors and are contra-rotating: They rotate in opposite directions around the common axis X.

They can be of the type with high-flow fan(s) and open rotor(s), also known as unducted fans (open rotor/ultra-high bypass ratio). The directions of rotation are indicated by arrows 12 and 15.

The solution in FIG. 1 could also be suitable for a turbomachine with unducted upstream 9 and downstream 6 blade assemblies of the USF (Unducted Single Fan) type, where downstream blade assembly 6 does not rotate around the axis X of the turbomachine. In other words, downstream blade assembly 6 is a swirl recovery stator. This case would be obtained for example by removing arm 19 mentioned below. FIG. 2 illustrates a type of turbine system which can be used to drive the rotation of at least one of blade assemblies 6 and/or 9 around the axis of the turbomachine and the pitch of at least one of these blade assemblies 6 and/or 9 around their respective axes 360,390.

In FIG. 2, the forward blade assembly or upstream blade assembly 9 (indicated by hatching lines) is attached to a first turbine 18 (also indicated by hatching) which rotates in direction 15 as indicated in FIG. 1. The rear blade assembly or downstream blade assembly 6 is attached, by arm 19, to a second turbine 21 and rotates in direction 12 of FIG. 1. A flow of gas passes through turbines 18 and 21. The air inlet for the air flow F intended for the turbine system is located at the upstream end of central engine 3, and denoted 31. Bearings 140 support the turbines and enable rotation. The hot, high-energy gas flow F is supplied by a combustion chamber (not shown) and causes the turbines to rotate. Bearings 140 support a rotating frame 141 fixed with the vanes of turbine stage 23.

Blade assembly blades 60 and 90 (which are sometimes called fan blades, propeller blades, or vanes because they have hybrid characteristics between propellers and fans) are of the variable pitch type. Variable pitch means that each blade, such as 60 and 90 respectively, can rotate around a respective pitch axis 360, 390, as indicated by the circular arrows 34. The main reason for changing the pitch is to give the blades the appropriate angle of attack for the aircraft's flight conditions and engine power setting. In addition, it is thus possible to adopt both a “puller” (propellers upstream of the combustion chamber, as in FIG. 4 or 5) and a “pusher” (propellers downstream of the combustion chamber, as in FIG. 1) configuration, therefore with open rotors on a CROR type of turbomachine (two contra-rotating blade assemblies, upstream 9 and downstream 6) and/or USF type of turbomachine (with a rotor upstream blade assembly 9 and a stator downstream blade assembly 6), FIG. 2 in principle being relatable to a “pusher” case. This solution could be applied to a “puller” case, by shifting blade assemblies 9, 6 upstream in the nacelle, therefore upstream of the combustion chamber; typically at the compressor(s).

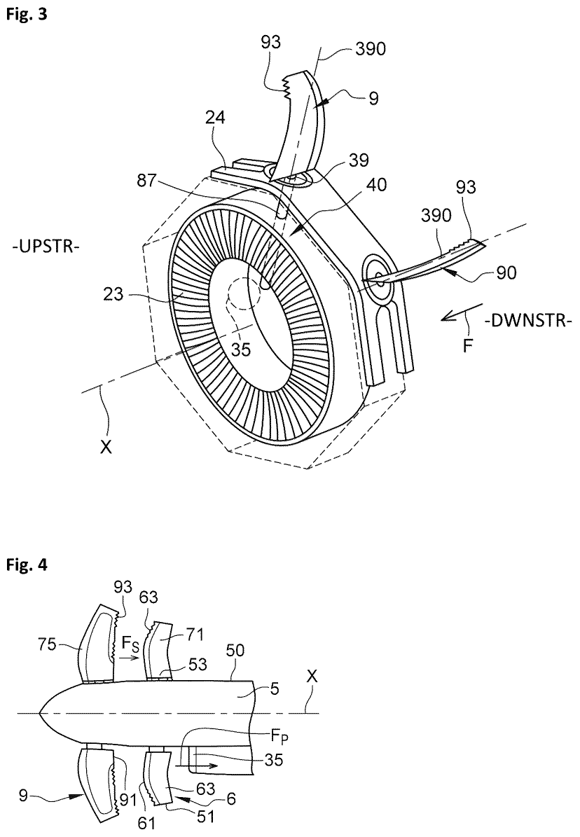

The motive power source which causes the pitch change is generally located within the annular path through turbines 18 and 21, as in region 35 of FIG. 2. Therefore, a mechanism is necessary to transport the mechanical torque from region 35, through the flow path of the stream (flow Fs in the example), towards blades 60 and 90. Such drive means (called the second means) 40 for rotating each blade concerned around its pitch axis 360, 390, via pitch arm 36 or 39 to which it is fixed, can be organized as follows: The blades of the blade assembly in question can be carried by an annular support 24, such as a ferrule or polygonal ring surrounding the turbine stage considered (23 in the cross-section of FIG. 2) which is shown in a schematic cross-section in FIG. 2, the turbine stage also being visible in FIG. 3. Annular support 24 therefore supports blades 90 of blade assembly 9, in the cross-section. For each open rotor blade, a radial shaft 87 passes through a turbine blade (radial shaft 87 and stage 23 in FIGS. 2 and 3). Shaft 87 is extended radially by a blade pitch arm 39 fixed to the blade root. The change in pitch indicated by arrows 34 can be caused by rotation between gears, via sub-planets of a compound planetary gear that are attached to a drive shaft. If the transmission ratio between the sub-planets and a fixed ring gear 54 is different from the transmission ratio between said sub-planets and a moving ring gear 52 (i.e. the system is a differential planetary system), then the rotation of the compound planetary gear could cause a relative rotation of ring gears 52 and 54, and thus cause the change of pitch 34. The same solution can be used for the pitch of downstream blade assembly 6: A second frame 142, rotating around axis X and fixed with the vanes of a downstream turbine stage located at downstream rotor 6 can be coupled to a frame 141 also rotating around the X axis and fixed with the vanes of the upstream turbine stage. The two frames 141, 142 are supported by bearings 140. Furthermore, the principle of FIG. 3 explained above can be applied: For each blade of open rotor 6, a radial shaft 87b identical to 87 can traverse a polygonal ring surrounding a vane of said downstream turbine stage 23.

In all the cases referred to here, if central engine 3 is a turbojet engine, it therefore successively comprises, along the X axis, one or more compressors, one or more combustion chambers, one or more turbines driving the compressor(s) via one or more axial drive shafts, and at least one hot gas outlet or pipe 33 downstream.

In a “puller” configuration, as in FIG. 4, in addition to the case of upstream 9 and downstream 6 blade assemblies forming two rotors, upstream blade assembly 9 alone can be a rotor, and downstream blade assembly 6 a stator.

The stator then comprises swirl recovery blades 60, to straighten part of the flow Fs, specifically a secondary air flow Fs which passes through the two propulsion units, in the case of a turbojet type of central engine 3 having an area for such a secondary air flow Fs, surrounding a primary gas flow path Fp.

In the “puller” configuration, air inlet 35 intended for the primary flow Fp of gas passing through central engine 3 can be downstream of the two upstream 9 and downstream 6 blade assemblies, as in FIG. 4.

However, one relevant solution is to locate air inlet 35 axially between the two upstream 9 and downstream 6 blade assemblies, as in FIG. 5 or 6. This location can in particular be between the respective pitch axes 390,360 of the blades of first series of blades 9 and second series of blades 6.

Nacelle 5, which can contain central engine 3, has, around the X axis, a circumferential wall with an aerodynamic external surface 50 relative to which first series of blades 9 and second series of blades 6 project, radially (or more generally transversely) to the central longitudinal axis X.

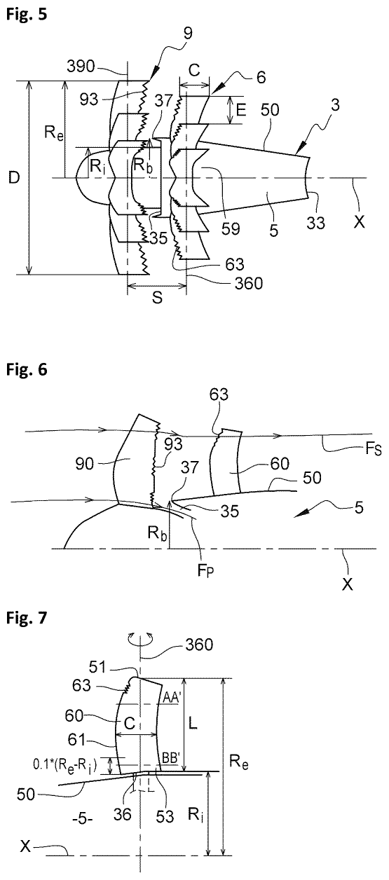

Each blade 90,60 of first series of blades 9 and second series of blades 6 has a pressure side (intrados) face 55 and a suction side (extrados) face 57 (see in particular FIGS. 1-2) and, along this radial direction (or therefore more generally transversal):
a free end 51 opposite to a connection end 53 forming a blade root close to nacelle 5,
a chord line C located at a defined radial radius, centered on the central longitudinal axis X (see for example FIG. 5),
a radius Ri between the central longitudinal axis X and a location which is level with external surface 50 of the nacelle, this location being situated:
   on the blade (at the blade root) or
   on a pitch arm 39 of the blade,
a radius Re between the central longitudinal axis X and a location on free end 51 of the blade farthest from the central longitudinal axis X, in a direction transverse to the central longitudinal axis X, and
a span L (see for example FIG. 7) defined as Re-Ri, which corresponds to a distance between free end 51 and connection end 53, in said transverse direction.

Note that this location on free end 51 of the blade may or may not be located on pitch axis 390 or 360 of said blade.

Chord line C can vary in the direction of the blade that is radial to the central longitudinal axis X.

Before further detailing this and other aspects below, it is important to remember that an element at the heart of the invention is as follows, in combination on the proposed propulsion unit 1 and considered as existing in all the figures (even if not identified):
at least one of the blades of first series of blades 9 has a trailing edge 91 having serrations 93, and,
at least one of the blades of second series of blades 60 has a leading edge (LE) 61 having serrations 63, and
at least some of blades 90 of first series of blades 9 have variable pitch, so that each of them can pivot around a pitch arm 39 to which the concerned blade 90 is fixed, about pitch axis 390 which at least partially traverses said blade 90, and/or
at least some of blades 60 of second series of blades 6 have variable pitch, so that each of them can pivot around a pitch arm 36 to which the concerned blade 60 is fixed, about the pitch axis 360 which passes through blade 60.

An alternating succession of at least two tooth tips and two troughs, for example as respectively denoted 630,631 and 632,634 in FIG. 18, defines a serrated area along the LE or the TE.

Preferably, the number of tips and/or troughs will preferably vary between 2 and 100 along span L.

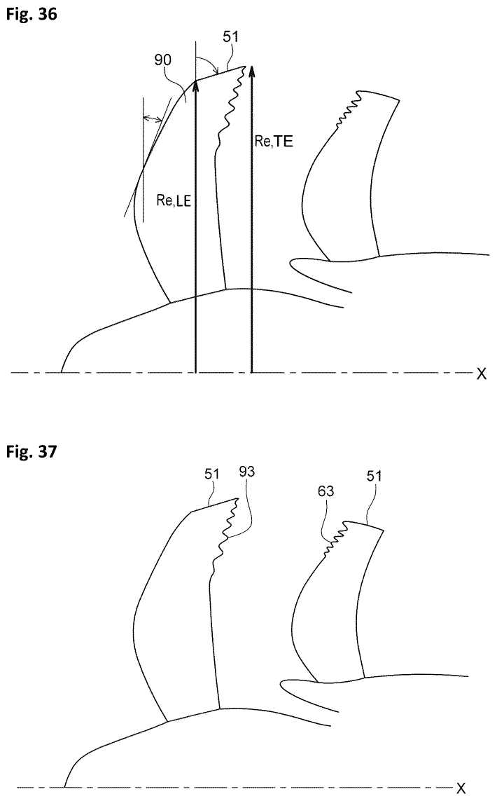

The pitch angle of blade 9 or 6 is symbolized by “γ” in FIGS. 9 and 35. The pitch of the profiles which define a blade can therefore vary according to the radius of the blade.

However, it is possible to define a reference pitch angle γ for a blade at a given radius, for example at 75% of radius Re.

Concerning the characteristic angles of a profile (for example in cross-section AA′ or BB′ in FIG. 7 or cross-section CC′ or DD′ in FIG. 34), one will also note (see FIG. 35) the interest of applying certain specific details to blades 9,6, together with some or all of the following, it being specified that, in accordance with the usual conventions:
the pitch angle (γ) of the blade considered is defined between the line or straight line A which connects the leading edge and the trailing edge of the blade considered (at a given radius) and the line X1 parallel to the central longitudinal axis X (“γ” thus defines the angle between a parallel (X1) to the central longitudinal axis X passing through the LE of the blade),
the skeleton angle at the LE (β1) considered is defined between:
   a line tangent to the skeleton line, measured at a distance “a” close to the LE, i.e. a/C<0.2 and preferably a/C<0.1 (“a” being the length, on line A, between the LE and a point along the chord line C), and
   a line parallel to the central longitudinal axis X,
the skeleton angle at the TE (β2) considered is defined between:
   a line tangent to the skeleton line, measured at a distance close to the TE, such that a/C>0.8 and preferably a/C>0.9, and
   a line parallel to the central longitudinal axis X;
the skeleton line is defined as the mean camber line (dotted line), halfway between the pressure side and suction side of the profile of blade 9 or 6.

It should be noted that the angles γ, β1, β2 vary in the direction radial to the central longitudinal axis X, meaning that these angles depend on the blade profiles at a given radial position (r) or along a streamline/friction of air near the surface of blades 90,60.

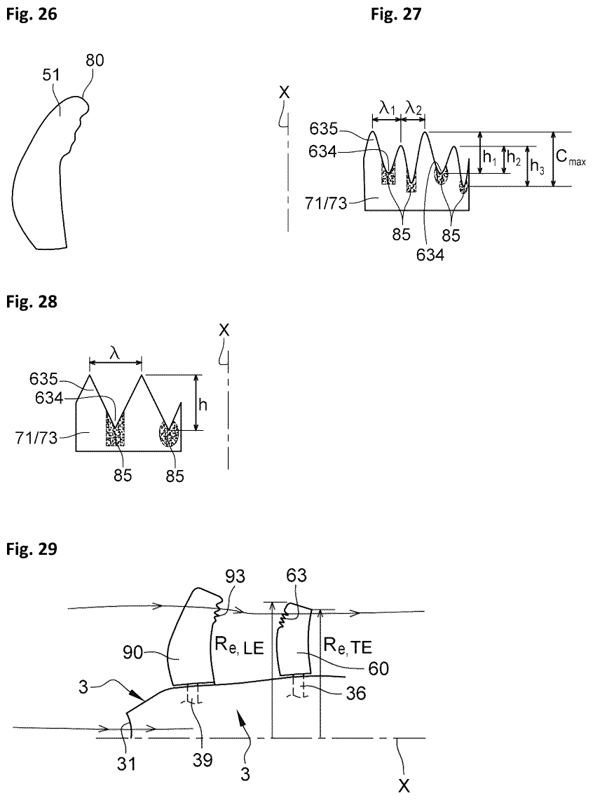

Angles β1, β2 allow characterizing the angle of incidence and the exit angle of the flow upstream and downstream of the blade profile. Thus, it is necessary to ensure that the incidence (or angle of attack) perceived by the blade profile(s) at the troughs (such as 632, 634 in FIG. 18 or 634 in FIG. 27) and at the tips (such as 630, 631 in FIG. 18 or 635 in FIG. 27) of the LE serrations are acceptable, and that there are no lift loss phenomena impacting the performance of the blades.

To this end, it is proposed that, in the LE (or TE) areas of blades 90,60 having serrations 93 and/or 63, the variation of the skeleton angle at the LE, Δβ1, (or at the TE, Δβ2) between a tooth tip 635 and a tooth trough 634 which are adjacent to one another, along span L of the considered blade 90 or 60, or in the direction radial to the X axis, is less than 45°, and preferably less than 25°, in an alternative or preferred embodiment.

Note also that, on a leading edge area or trailing edge area having serrations, a variation in skeleton angle (Δβ1 below) at the leading edge or (Δβ2 below) at the trailing edge, between a tooth tip and a tooth trough (or valley) which are adjacent to one another, along the span of a blade, or radially to the central longitudinal axis (X), may beneficially be greater than 0° and less than 45°, or in some cases even 30°. This will avoid cases of isolated profiles.

Indeed, it has been shown that:
the angle of attack of the air as perceived by the blade profile(s) at the troughs and tips of the LE serrations is then suitable, and/or
there are no lift loss phenomena impacting the performance of the blade(s).

Other considerations of a comparable nature may usefully encourage giving preference to at least one of the following considerations:
i) a variation in pitch angle (Δγ) of less than 45°, and preferably greater than 0°, between (a profile containing) a tooth tip and (a profile containing) a tooth trough that are adjacent to one another,
   along the span (L) of blade 9 or 6, or
   radially to the central longitudinal axis (X), and/or
ii) on a leading edge or trailing edge area of a blade 9 or 6 having serrations, a variation in skeleton angle (Δβ1) at the leading edge or (Δβ2) at the trailing edge that is less than 45°, and preferably greater than 0°, between two tooth tips adjacent to one another and/or between two tooth troughs, respectively adjacent to one another (from tip to tip and/or from trough to trough),
   along span (L) of the blade, or
   radially to the central longitudinal axis (X), and/or
iii) a variation in pitch angle (Δγ) that is less than 45°, and preferably greater than 0°, between two (profiles containing) tooth tips adjacent to one another,
   along span (L) of blade 9 or 6, or
   radially to the central longitudinal axis (X), and/or
iiii) a variation in pitch angle (Δγ) that is less than 45°, and preferably greater than 0°, between two (profiles containing) tooth troughs adjacent to one another,
   along span (L) of blade 9 or 6, or
   radially to the central longitudinal axis (X), and/or
iiiii) on a leading edge area or trailing edge area of a blade 9 or 6 having serrations, a variation in skeleton angle (Δβ1) at the leading edge or (Δβ2) at the trailing edge that is less than 45°, and preferably greater than 0° (in absolute value), between (a profile containing) a tooth tip and (a profile containing) a tooth trough that are adjacent to one another,
   along span (L) of blade 9 or 6, or
   radially to the central longitudinal axis (X).

FIGS. 42 and 43 illustrate this, with tooth tips 935, 635 and tooth troughs 934, 634, therefore respectively on examples of blades 9 and 6, tooth tips 935 and troughs 934 being adjacent to one another.

In order to reduce noise, it is further proposed that:
first series of blades 9 and second series of blades 6 may have different numbers of blades, for example as shown in FIG. 1, preferably each between 5 and 20; this can make it possible to decorrelate the acoustic radiation of the upstream and downstream blades, and/or
the blades of first series of blades 9 and/or second series of blades 6 are located on a closed line centered on the central longitudinal axis X and having a diameter D, with
blade pitch axes 390, 360 respectively of first series of blades 9 and second series of blades 6 which will be axially separated, pairwise, by a distance S, and
an S/D ratio which will be between 0.005 and 1, and preferably between 0.15 and 0.70, or even between 0.20 and 0.50.

Thus, it will be possible to effectively dissipate the turbulent wake from the upstream blade assembly 9 during its propagation downstream. The wakes which arrive at leading edge 61 of downstream blade assembly 6 will be relatively low in energy.

In one case, D could thus correspond (as is conventional) to the maximum diameter of upstream blade assembly 9.

Furthermore, trailing edge 91 of each of blades 90 of first series of blades 9 is located longitudinally upstream of a leading edge of each of blades 60 of second series of blades 6.

This thus avoids interference between the series of blades.

In relation to noise, it is also proposed that each blade has, on first series of blades 9 and/or on second series of blades 6 and at a defined common radius:
a circumference segment length E between two successive blades of the circumference,
a C/E ratio such that C/E<2.5 at any radial position along the span of the blade, and such that C/E<0.8 at the free end.

Low solidity C/E of blades 90, 60 will increase the size of the inter-blade channels 59 (FIG. 5, meaning the spacing between two consecutive blades in the azimuthal/circumferential direction). This can avoid the formation of shock waves in the inter-blade channel at high rotation speed in certain operating points, which is linked to the contraction of the flow in each channel 59. These shock waves are the cause of “shock noise” or “buzz-saw noise”.

Various studies have also demonstrated that noise reduction can be facilitated if, the two blade assemblies 90,60 being assumed to be contra-rotating rotors, the speed of rotation around the X axis of upstream blade assembly 90 is greater than that of downstream blade assembly 60.

To adapt a rotation speed of a blade assembly, such as upstream blade assembly 9, a speed reducer which can be planetary may be used, such as speed reducer 104 presented below.

In this case, the blades of first series of blades 9 and of second series of blades 6 will therefore be arranged to be able to be rotated around the central longitudinal axis X by a free power turbine, in a contra-rotating manner. One example is disclosed in EP2368030.

It should be noted that increasing the rotation speed of downstream blade assembly 6 can increase the relative speed at the blade tip 51 of the downstream blade assembly, which could become transonic (therefore generating shock waves, etc.).

In the example of FIG. 30, the gas turbine central engine (core engine) 3 operates in a conventional manner, so that the air entering inlet 35 is accelerated and compressed by low-pressure compressor 920 and directed towards high-pressure compressor 92 where additional compression takes place. Compressed air discharged from high-pressure compressor 92 is directed to combustion chamber 930 where it is mixed with fuel and the mixture is burned. The resulting hot combustion products expand and thus drive high-pressure 94, low-pressure 98, and free power 96 turbines before being discharged at 33 by nozzle 97 to provide a certain propulsive thrust. The high-pressure, low-pressure, and free power turbines, respectively 94, 98, 96, respectively drive high-pressure 92 and low-pressure 920 compressors and open rotors 9, 6, by appropriate interconnecting shafts. The two open rotors 9,6 are contra-rotating, fixed to and driven by free power turbine 96, via contra-rotating blade arrays 90, 60, 99.

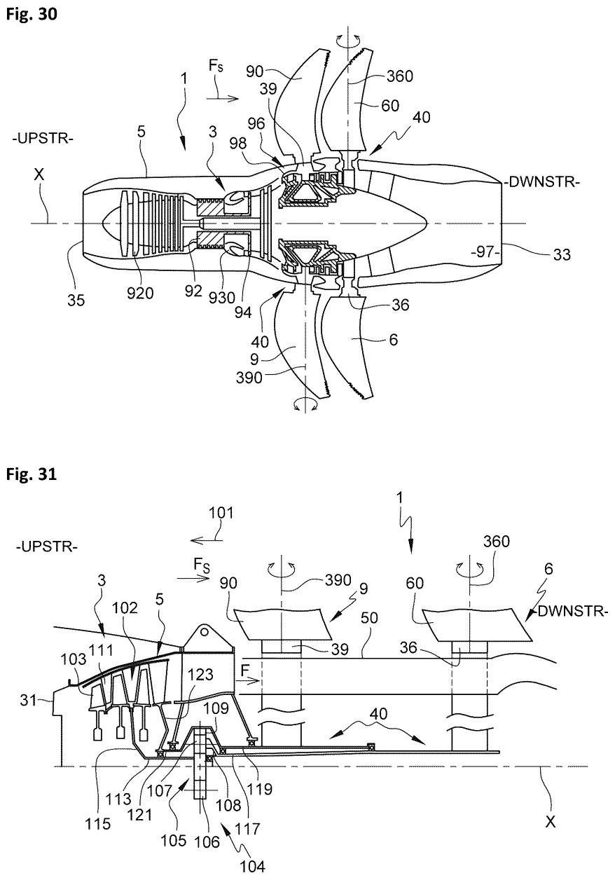

The example in FIG. 31 shows a situation where the aircraft turbomachine comprises:
a free power turbine 102 comprising a rotor 103;
a downstream blade assembly 6 and an upstream blade assembly 9, with the upstream blade assembly intended to be rotated about a central longitudinal axis X of the propeller system, relative to a stator of this system which can be nacelle 5; this stator may also be a blade or fixed vane of another blade assembly, for example, blade 6 of the second series of blades in a USF type of turbomachine, and
a mechanical transmission device comprising a reduction speed gearbox or speed reducer 104 (or simply gearbox) between an input shaft driven by the turbine, such as shaft 121 below, and the blades of upstream blade assembly 9, in order to reduce the rotation speed of blades 90 and therefore the noise generated by this blade assembly.

This can be extrapolated to a USF, for example by removing the downstream part of planet-carrier shaft 117 attached to downstream blade assembly 6.

In this example, however, this is a CROR where downstream blade assembly 6 and upstream blade assembly 9 are therefore contra-rotating, intended to be rotated together around a longitudinal axis X of the propeller system, relative to nacelle 5.

Rotor 103 is a first rotor 103.

Speed reducer 104 comprises a planetary gear train 105 provided with a sun gear 107 centered on said longitudinal axis X and driven by first rotor 103 of free power turbine 102, at least one planet gear 106 meshing with sun gear 107, one or more planet carriers 108 driving downstream blade assembly 6, as well as a ring gear 109 meshing with each planet gear 106 and driving upstream blade assembly 9.

Free power turbine 102 also comprises a second rotor 111 contra-rotating relative to said first rotor 103, and rotating the ring gear 109.

Sun gear 107 centered on the longitudinal axis X is carried by a planetary shaft 113 of the same axis, integrally connected upstream to first rotor 103, by a flange 115. Thus, first rotor 103 directly drives sun gear 107 in rotation, which can take the form of a gear wheel with external teeth.

Planet carrier 108 is carried by a planet carrier shaft 117 of the same axis, secured to downstream blade assembly 6. Ring gear 109, centered on the X axis, is carried by a ring gear shaft 119 of the same axis. Ring gear 109 meshes with each planet gear 106. Shaft 119 extends downstream while being integral with upstream blade assembly 9, so as to be able to rotate it directly. Shaft 119 may be located around planet carrier shaft 117, with which it is then concentric. Ring gear 109, taking the form of a gear wheel with internal teeth, is also carried by another ring gear shaft 121, of the same axis, and extending upstream. Ring gear shaft 121, located around planetary shaft 113 with which it is concentric, is integrally connected to second rotor 111, via a coupling 123. The aircraft is advancing in direction 101.

More details can be found in WO2010070066.

In the solutions of both FIG. 30 and FIG. 31, (second) drive means 40 are of course also provided to rotate each blade 90,60 concerned around its pitch axis 390 or 360, via pitch arm 39 or 36 to which it is fixedly linked. For this purpose, the solution in FIGS. 2,3 can be applied, for example.

Again to combat noise, one can consider leading edge serrations 63 and/or those 93 of the trailing edge being mainly located, preferably only located:
beyond 0.4×(Re-Ri), starting from the connection end 53 side, and/or
at (in proximity to) the radial position where chord line C is maximal, over a length of 0.2×(Re-Ri) to 0.8×(Re-Ri) around the maximal chord line position.

In particular, a length of about 0.3×(Re-Ri) around the maximal chord line position may be suitable.

Near free ends 51 of the blade, the serrations allow reducing the noise related to the blade tip vortex. If the serrations are at trailing edge 91, towards the free end of upstream blade assembly 9, serrations 93 allow improving the wake mixing and therefore reducing the intensity of the blade tip vortex.

Trailing edge serrations 91 also allow reducing the inherent noise linked to the passage of the turbulent boundary layer which develops on the pressure side (intrados) and suction side of blade (extrados) 90 and which radiates noise at trailing edge 91.

If serrations 63 are located at leading edge 61 of downstream blade assembly 6, this makes it possible to reduce the interaction noise and to better decorrelate the sources of noise along span L.

The advantage of trailing edge serrations on the profiles of blade 90, 60 having a large chord line C (C>Cmoy, where Cmoy is the average chord line of the blade) is to reduce the inherent noise linked to the boundary layer, which becomes thicker on profiles with large chord lines (see FIGS. 32,33: cross-sections AA′ and BB′). Serrations 93 at trailing edge 91 of upstream blade assembly 9 also lead to a reduction in the interaction noise (broadband and tonal) between the wake and the downstream blade assembly, because turbulence mixing and the average speed deficit in the wake are accelerated.

The disadvantage from an acoustic point of view, however, is limiting the areas of the leading edge and trailing edge which can contribute to noise reduction via the presence of serrations.

However, limiting the areas of the LE and TE having serrations makes it possible to limit the possible aerodynamic losses, which allows finding an advantageous aero-acoustic compromise. Yet another noise reduction factor can be identified, when, as for example in FIG. 4 or 5:
first series of blades 9 and second series of blades 6 are located towards an upstream end of central engine 3 (“puller” configuration),
nacelle 5 has an air inlet 35 which can in particular be an inlet for the primary air flow Fp towards central engine 3, and
on nacelle 5, air inlet 35 is located axially between first series of blades 9 and second series of blades 6, and even more precisely, and preferably, between the respective pitch axes 390, 360 of the blades of first series of blades 9 and second series of blades 6.

This makes it possible to reduce span L (and therefore radius Re) of downstream blade assembly 6, particularly in connection with clipping. The size of a blade 90 or 60, and in particular its span, is a contributor to the radiated noise. Such a configuration will therefore reduce the noise of the turbomachine.

On the nacelle, air inlet 35 can be placed over 360° (ring) or only along an angular sector.

FR3083207 refers to this. Air inlet 35 may have a lip 37 projecting from nacelle 5.

To reduce the interaction of the wake of upstream blade assembly 9 with lip 37, and therefore reduce noise, it may be provided, for example as in FIG. 6, that:
on nacelle 5, lip 37 of air inlet 35 is located at a radius Rb from the central longitudinal axis X, and
trailing edge 91 of first series of blades 9 has serrations 93 located at radius Rb.

In this case, as in the embodiment of FIG. 5, we again find advantages linked to the fact that the pair of blade assemblies 9,6 is positioned in a “puller” configuration, with the air inlet for the primary flow being located between upstream blade assembly 9 and downstream blade assembly 6.

However, serrations 93 at the trailing edge of the blades of the upstream blade assembly could disrupt the supply (air flow) which arrives at inlet 35 for the primary flow.

In a USF type of configuration, arranging for downstream blade assembly 6 to be a stator/swirl recovery assembly which does not rotate around the central longitudinal axis X, unlike upstream blade assembly 9, but in which each blade 60 can rotate around its pitch axis 360, could also be advantageous from an aerodynamic and acoustic point of view.

In this case, the turbine of the central engine will be connected to first series of blades 9 in a manner that only rotates the blades of first series of blades 9, the blades of second series of blades 6 defining swirl recovery vanes. Only blades 90 of first series of blades 9 will therefore be arranged to be rotatable around the central longitudinal axis X by the turbine that drives blades 90, which can be a free power turbine. The blades of second series of blades 6 define stator swirl recovery vanes (also called outlet guide vanes).

It is then useful to interpose a speed reducer (such as 104 mentioned above) between blades 90 of upstream blade assembly 9 and the shaft of the turbine which drives blades 90, in order to reduce the rotation speed of this blade assembly, which optimizes the aerodynamic performance of the blade assembly and reduces the noise it generates.

The advantage of a USF configuration compared to a CROR is that it presents less tonal noise, with fewer “lines/peaks” in the spectrum. Indeed, in a CROR, one can distinguish the Blade Passing Frequencies f (BPF) of each blade assembly (upstream/downstream) and its harmonics, as in FIG. 11. In addition, there are “combination/interaction lines” in the SPL sound spectrum of a CROR. However, in an SPL sound spectrum of a USF there are only the BPFs linked to the upstream blade assembly (as in FIG. 12), which should allow reducing the acoustic levels. In the case of a USF, these BPFs are primarily linked to the aerodynamic load noise on the rotor blades (upstream blade assembly) and to the interaction of the rotor wakes—characterized by an average speed deficit—with the stator.

From a mechanical/integration point of view, a USF type architecture is simpler to implement (fewer rotating parts in particular) than a CROR architecture.

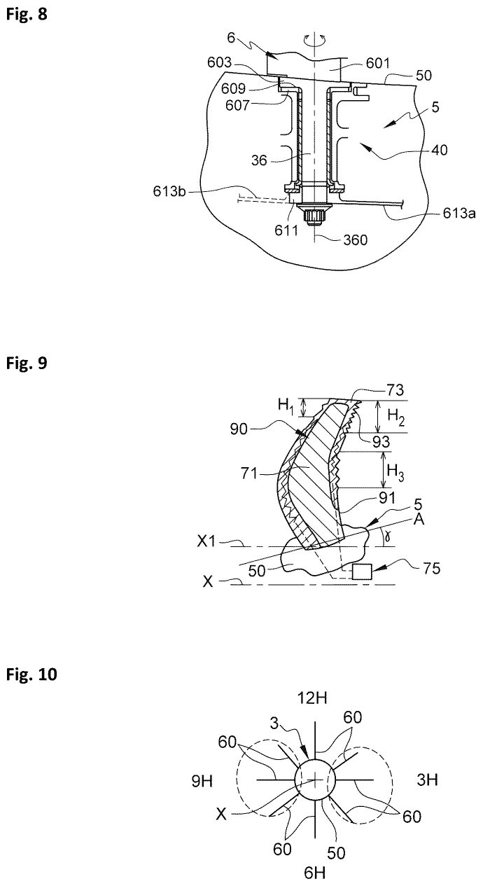

FIG. 8 illustrates, by way of non-limiting example, a solution of (second) drive means 40 for rotating each swirl recovery vane concerned, about its pitch axis 390 or 360, via pitch arm 39 or 36 to which it is fixedly linked. This is a hinged system which allows adjusting the pitch of each swirl recovery vane 60 (outlet guide vane) if downstream blade assembly 6 is of the stator type. This solution is therefore suitable for a USF configuration and can be coupled to an upstream blade assembly 9 which would be controlled, for example, as in FIGS. 2 and 3, after eliminating arm 142 and connecting lever 613a or 613b hereinafter mentioned as adapted actuating members, which are known in themselves.

Variable-pitch swirl recovery vane 60, in the example, can be rotated radially through external surface 50, within a casing that is part of nacelle 5. The vane comprises a vane portion 601, a plate 603, and a rod or pivot defining pitch arm 360. Pivot 36 is housed in a radial hole provided in casing 5. A bearing of pivot 39 consists of a sleeve 607 in sliding contact with pivot 36.

Sleeve 607 secured to the casing is in contact with plate 603 via a circular boss 609. The opposite face of plate 603 relative to the sleeve is swept by the air which passes through the two blade assemblies 9,6. A centering ring 611 keeps the vane in its housing. A lever controls the rotation of the blade 60 concerned around pitch axis 360 of the pivot in order to place the blade in the required position (see double arrow in FIG. 8) relative to the air flow sweeping the vane. The relative movements result from the sliding of the surfaces in contact, here pivot 36 and plate 603 with sleeve 607. The lever extends either downstream (lines 613a, particularly in the case of a pusher propulsion unit), or upstream (dotted lines 613b, particularly in the case of a puller/tractor propulsion unit). The members which actuate lever 613a or 613b are not shown; they comprise an actuator and a control which, together, can also actuate blades 90 to position them each around their axis 390, as already explained in connection with FIGS. 2,3. For further details, reference can be made to EP17174450.

Concerning the noise sources characteristic of an open rotor engine, the acoustic radiation of an aerodynamic profile is similar to that of a dipole (two main lobes of radiation), in which the preferred direction of propagation is normal to the chord line of the profile (see FIG. 10). Swirl recovery vanes 60 located at 6 o'clock and 12 o'clock in a USF architecture will thus contribute to lateral noise levels (at the sides) of the aircraft. Stators located at 3 o'clock and 9 o'clock in a USF architecture will contribute to noise levels above and below the aircraft. As an effect on the ground-track noise radiated during the take-off and landing phases, one embodiment proposes applying serrations only to the swirl recovery vanes which are primary contributors to the radiated ground-track noise. Even if an optical effect may suggest it in FIG. 10, the span of the blades (L=Re-Ri) can be constant over the entire periphery of the blade assembly considered.

It is also proposed that, as in FIG. 10, circumferentially around the central longitudinal axis X, only swirl recovery vanes 60 located within a first angular range of +/−60° relative to 3 o'clock, and within a second angular range of +/−60° relative to 9 o'clock, have serrations, denoted 63 in other figures.

This is a compromise between anti-noise effectiveness/costs and aerodynamic performance.

Yet another aspect can usefully contribute to combating noise: serrations 93 and 63 are respectively located on trailing edge 91 of upstream blade assembly 9 and on leading edge 61 of downstream blade assembly 6.

In fact, serrations 93 at the trailing edge of the upstream blade assembly have the dual advantage of:
(i) reducing the blade's self-noise (linked to the acoustic radiation produced by the boundary layer on the surfaces of the blades as it passes the trailing edge), and
(ii) improving wake mixing, which reduces the intensity of the blade tip vortex and the average speed deficit when it impacts downstream blade assembly 6.

The advantage of serrations 63 at the leading edge of downstream blade assembly 6 is to reduce the noise resulting from the interaction of the wake and the blade tip vortices on upstream blade assembly 9 which can interact with the downstream blade assembly. An advantage is therefore to reduce (or avoid) clipping at the blade end in the downstream blade assembly. Indeed, reducing clipping in blades 60 of downstream blade assembly 6 makes it possible to improve aerodynamic performance because an additional part of the flow's gyration at high radii, close to the outside limit of radius Re, is recovered at end 51 of the blade in downstream blade assembly 6. This therefore makes it possible not to increase the chord line of downstream blade assembly 6 (in order to ensure the same bearing surface as that of a downstream blade assembly without clipping), particularly in the case of a CROR.

Combining serrations 93 at the TE and 63 at the LE in this manner, however, increases the complexity of the system and the costs of implementation compared to a dissociated solution as proposed further on in the description. Indeed, the more serrations the blades have, the more complex and expensive the parts are to produce (possibly more deviations/non-conformities to deal with, more manufacturing defects, etc.). The mechanical impacts linked to increasing chord line C of a propulsion unit are furthermore as follows: Increasing chord line C by decreasing span L makes the blade less resistant to bird intake at the LE/TE and above all it becomes more difficult to integrate because of the variable pitch: the blade can protrude from its platform which causes aerodynamic leakage in a manner radially internal to the blade root, the radially internal part of the blade root tends to be highly loaded mechanically, the moment of inertia increases, which generates significant torque around pitch axis 390 or 360 and therefore a pitch change system and a feathering system to be adapted. The integration of such a blade can negatively impact the hub ratio, Ri/Re.

The leading and trailing edges of blade 9 can in fact protrude beyond the (circular) platform at the root of the blade. The circular platform is integral/rotates with blade 9, but annular support 24 and the wall of nacelle 5 are fixed. This implies that unwanted air leakage can exist between the blades and the wall of the nacelle at the LE and TE, at the blade root.

Several tooth geometries or patterns for the serrations can be used individually or in combination at the leading edge and/or trailing edge of blades 9,6: teeth having a shape that is sinusoidal, square, rectangular, slots/grooves, etc. The advantage of using several patterns is to reduce correlation of noise sources along the LE and/or TE, which should foster noise reduction; see the information provided elsewhere about angles γ, β1, β2 and the shapes of the serrations, such as the rounded 81 or elliptical 79 shapes presented herein after.

The serrations could vary (be different) between the different blades 90,60 of a same blade assembly (upstream and/or downstream) and/or between at least some of the blades of first series of blades 9 and at least some of the blades of second series of blades 6, according to at least one of the following characteristics: pattern (or geometry), amplitude, spacing, radial positioning of the serrations along the span. This would make it possible to define several families of blades, for example with different geometric patterns. One could therefore vary the geometry for one or more blades (the chord line, the camber, the maximum thickness, etc.), in order to define a blade assembly 9,6 having heterogeneous blades 90,60. An advantage of using several patterns of different geometries at the leading edge of each blade 90 and/or 60 is to reduce the correlation of noise sources. This can be of particular interest if the solidity of blade assembly 9 or 6 is high or if the size of the vortex structures is significant.

Furthermore, the advantage of using several different geometric patterns at the trailing edge of the upstream blade assembly is that it improves wake mixing.

The search for noise reduction can also be combined with other considerations. The following order of these considerations is not related to their importance.

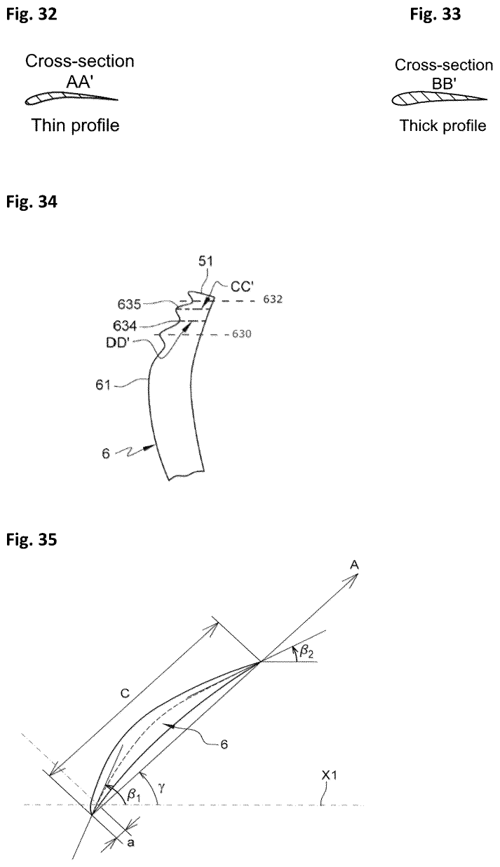

First consideration: One can seek to ensure the improved mechanical strength of blades 90 and/or 60, during nominal operation of the turbomachine, and in the event of bird intake. The mechanical forces on blades having serrations on the LE/TE could be greater than a reference case with smooth LE/TE. Therefore, to improve the mechanical strength of blades having serrations, it is proposed that:
each blade 90,60 having serrations of first series of blades 9 and/or second series of blades 6 has a maximum thickness (indicated e in FIG. 2) between pressure side (intrados) face 55 and suction side (extrados) face 57, and
on the blades, the maximum thickness of the blades is located near blade root 53, at a distance of less than 0.1×(Re-Ri) from connection end 53 (end located at radius Ri). See section AA′ and BB′ in FIGS. 7, 32, and 33.

Second consideration: One can seek to ensure a hub ratio which varies within a range that allows guaranteeing a good compromise between aerodynamic requirements (large blades hence a low Ri/Re ratio) and the requirements for integrating additional systems into the hub, meaning under surface 50 (a device for varying the pitch of the blades, oil and air pipes, etc., therefore a high Ri/Re ratio).

It is therefore proposed that each blade 90 and/or 60 with serrated LE and/or TE of the first series of blades and/or the second series of blades can have a hub-to-free end ratio Ri/Re such that Ri/Re is between 0.10 and 0.50.

Third consideration: One can seek to improve the mechanical strength of the blades, particularly in the event of bird intake.

It is therefore proposed that the serrations, such as 93 or 63, have, per blade or on at least one of said blades 9 or 6, an amplitude h(r) (which can be the maximum) between a tip 635 and a trough 634 which are adjacent, such that: 0.0005×Cmax≤h(r)≤0.5×Cmax, where:
Cmax is the maximum chord line of the blade, and
h(r) corresponds here to the difference (if necessary the maximum) in chord line C between a profile at a tip 635 and a profile at a trough 634 which are adjacent, along the direction of the span (L) of the blade or radially to the central longitudinal axis (X).

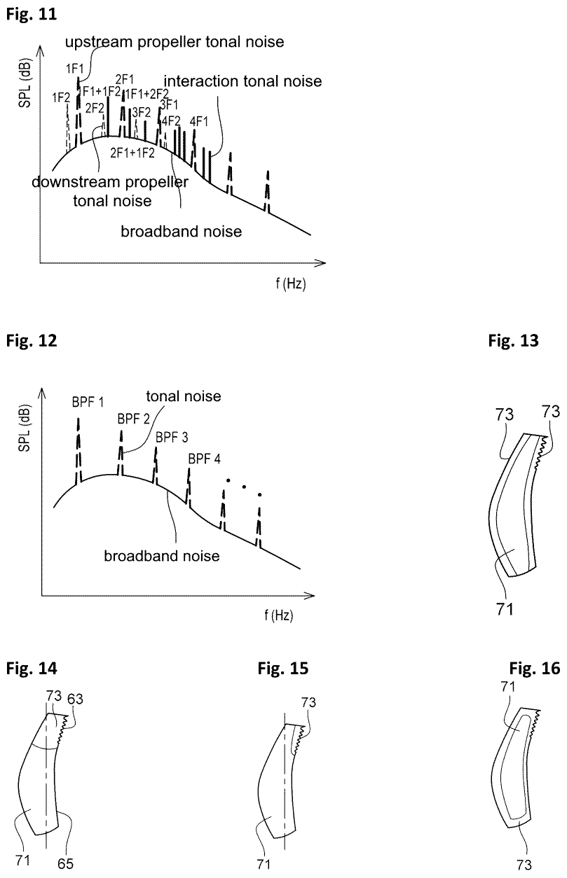

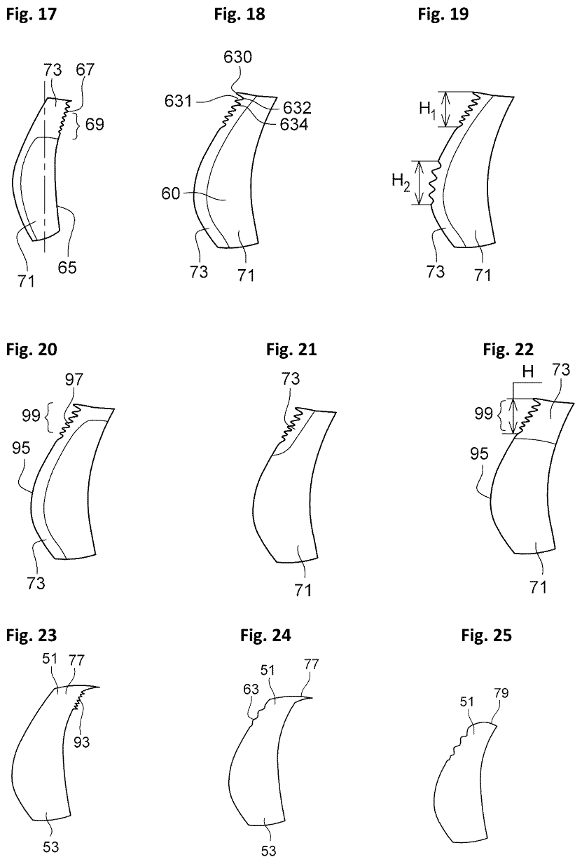

FIGS. 13 to 26 are in accordance with this.

Amplitude (hr, such as h1,h2 . . . ) otherwise also has the meaning: depth of the serrations between the tip and valley of the tooth considered, see FIG. 27 for an illustration in which the principle is applied to FIGS. 13 to 26. Serrations, such as 93,63, that are too deep could have a negative impact on the aerodynamic performance of the blades and present difficulties for the mechanical strength of the blades in the event of bird intake.

Fourth consideration: One can seek to adapt the geometry of the serrations according to the local characteristics of the gas flow.

It may therefore usefully be provided that:
serrations 93,63 at leading edge 61 and at trailing edge 91 have geometries or patterns that are different from each other, and/or
serrations 93 of some of the blades of first series of blades 9 are different from serrations 63 of some of the blades of second series of blades 6.

In the case for example of trailing edge serrations, their amplitude and spacing could usefully be sized according to turbulence values of the boundary layer at the trailing edge of the blade, where for example the serrations could be defined as a function of the spatial correlation length of wall pressure fluctuations along the trailing edge or as a function of the boundary layer thickness. In the case of leading edge serrations, their amplitude and spacing would be sized according to the aerodynamic values of the incident flow (atmospheric turbulence, upstream blade wakes, etc.). In this case, one of the preferred sizing parameters could be the turbulence integral scale.

It is therefore proposed that, as illustrated in the examples in FIGS. 14, 19, 20 (where the amplitude and spacing h(r) and λ(r) can be understood from the illustration in FIG. 27), on at least some of blades 90 and/or 60, the serrations have an amplitude h(r) and a spacing between two successive serration tips λ(r), which vary. It should be noted that h(r) and λ(r) can be functions defined piecewise along span L of blade 90, 60 as a function of radial position r.

Fifth consideration: In addition to improving the mechanical strength of the blades and the geometry of the teeth, particularly in the event of bird intake, one can seek to simplify the manufacturing of the blades, because in principle it is simpler to machine complex geometries on metal parts than on composite parts (typical fibrous material for the manufacture of blades 90, 60). In addition, a cap or sheeting 73 with LE and/or TE serrations could be sold or marketed as an option for aircraft manufacturers and/or airlines wishing to have improved acoustic performance. Providing serrations solely on a mechanical cap (for example made of metal) can also simplify maintenance operations and improve resistance to erosion.

It is therefore proposed, as shown schematically in FIG. 13 and subsequent figures, that at least some of blades 90, 60 comprise a composite material 71 and, on pressure side face 55 and/or suction side face 57, at least one metal cap 73 for mechanical reinforcement is fixed to the composite material and extends along at least part of the leading edge and/or trailing edge.

The metal cap(s) may not be solely along the leading or trailing edges.

There may also be reinforcement plates on the surface of pressure side 55 and/or suction side 57. The weight must be considered; as must the removability of composite material 71 of the blade, therefore replaceability, from cap 73 as well.

Sixth consideration: Reducing the weight of the blades will also reduce fuel consumption of the aeronautical propulsion unit on which the pair of blade assemblies 9,6 is installed. It is therefore proposed that the blade (or its composite portion, such as portion 71) is an assembly of organic materials (thermosetting resins, thermoplastic resins) possibly reinforced with carbon fibers according to one of the many possible manufacturing processes (weaving, braiding, lamination, winding, etc.). The reinforcing fibers may also be glass, Kevlar, or aramid fibers.

Seventh consideration: One can seek to limit the number of parts to be manufactured and optimize the mechanical strength of the blade.

It is therefore proposed that, per blade 90 or 60, the reinforcement or cap 73 connects the LE to the TE via free end 51 of the blade. This will be of particular interest in the event of serrations being present on the reinforcement or cap 73. Examples can be seen in particular in FIGS. 16, 17, 20, 22.

Eighth consideration: One can seek to reduce the intensity of the blade tip vortex of free end 51, in order to reduce the interaction of the blade tip vortex of end 51 of upstream blade assembly 9 with downstream blade assembly 6.

It is therefore proposed, as illustrated in a few examples in FIGS. 23, 24, that free end 51 of at least one of blades 90 or 60 presents a “proplet” or an abrupt change in the slope angle, denoted 77.

Ninth consideration: One can seek to reduce the intensity of the blade tip vortex of end 51 of the blade, and therefore the interaction of the blade tip vortex of end 51 of upstream blade assembly 9 with downstream blade assembly 6.

It is therefore proposed, as illustrated in a few examples in FIGS. 25, 26, that:
free end 51 of at least one of blades 90 or 60 has an elliptical shape 79, or
this blade head 51 has a rounded shape 81 and therefore the LE and TE lines converge (or are coincident) at free end 51 of the blade.

Thus, the lines of the leading edge, such as 61, and the lines of the trailing edge, such as 91, will tend to be coincident.

Tenth consideration: One can seek to facilitate manufacturing and maintenance overall, and thus reduce intervention times.

It is therefore proposed that, as illustrated, the serrations are formed only on metal reinforcement cap 73, not on composite material 71.

Eleventh consideration: One can seek to avoid the accumulation of ice on the leading/trailing edges, which can significantly degrade performance (reduced thrust, reduced efficiency, boundary layer separation, etc.).

It is therefore proposed that the aeronautical propulsion unit comprise a heating device, for defrosting or anti-icing functions, and which could be connected to the metal reinforcement cap 73.

As illustrated as an example in FIG. 9, a heating device 75, which may comprise resistors or channels for the flow of a hot fluid, in metal reinforcement cap 73, may therefore be added and connected to this cap from the inside of nacelle 5. It will then be necessary to accommodate a possible increase in the thickness of the blade at the LE and/or TE in order to integrate the defrosting system into a relatively small footprint.

Twelfth consideration: One can seek to limit the weight of blades 90 and/or 60.

It is therefore proposed, as illustrated in the examples in FIG. 13 and subsequent figures, that reinforcement cap 73 of the blade occupies less than 50% of the total volume of the blade, and preferably less than 25% of the total volume of the blade.

Thirteenth consideration:

One can seek to increase the mechanical strength of the leading edge and/or trailing edge having serrations. Indeed, the teeth/serrations may have particularly elongated (FIG. 27) or pointed (FIG. 28) tips.

It is therefore proposed, as illustrated in the examples in FIG. 13 and subsequent figures, that the protection of the leading edge and/or trailing edge and/or blade head 90 and/or 60 (free end 51) be manufactured of metal, with reinforcement cap 73 integrated or attached by removable or non-removable attachment, titanium or titanium alloy, steel, nickel or nickel alloy, stainless steel.

Fourteenth consideration: One can seek to increase the crack resistance of a blade reinforced by a metal reinforcement 73 comprising serrations.

It is therefore proposed that removable metal reinforcement 73 comprising serrations be bonded to the blade of composite material 71 by using an epoxy glue. The glue may be reinforced with thermoplastic or elastomeric nodules. This assembly method is relevant for a metal/composite assembly.

Additionally or alternatively, one can also use assembly by geometry: for example, metal insert 73 with a local dovetail shape, and a cavity of complementary shape in composite 71, or vice versa. The advantage then lies in the possibility of changing only metal reinforcement 73 (removable) in the event of damage caused by a bird strike or by erosion.

Whether there is metal reinforcement 73 or a blade 90 or 60 made entirely of composite material, the serrations can therefore be produced by a mechanical machining process, forging or foundry (if metal), additive manufacturing, or chemical milling.

Fifteenth consideration: One can seek to limit the locations which have serrations to only what is needed to maximize acoustic gain while minimizing the impact on aerodynamics (efficiency) and mechanics (resistance in the event of bird intake, erosion, etc.).

It is therefore proposed that the serrations at the LE and/or TE are not in one single portion/along one length but occupy several regions of the LE and/or TE, separated by areas having a smooth LE and/or TE, as illustrated as examples in FIGS. 14, 15, 21, 22 in particular.

Sixteenth consideration: One can also seek to define a connection area between the smooth portions(s) and those with serrations, which is of interest from an aerodynamic and mechanical point of view.

It is therefore proposed that, on at least some of blades 90, 60:
a first portion of the leading edge and/or the trailing edge, such as 61 and/or 91, is smooth, without serration, such as along areas 95 and/or 65 of blades 90, 60, and in particular near the blade root, therefore at a distance of less than 0.1×(Re-Ri) from connection end 53,
a second portion 97 and/or 67 of the leading edge and/or the trailing edge has said serrations, and
the amplitude of the serrations at (in proximity to) the radial position where the second portion is connected to the first portion, evolves monotonically and even strictly monotonically (in particular by decreasing), such that the connection is progressive: connection areas 99 and/or 69; see for example FIGS. 14, 17, 20, 22, with 69 and 99 being denoted in only some of these figures.

Seventeenth consideration: One can also seek to limit possible aerodynamic losses and difficulties/costs linked to manufacturing serrations at the leading edge and/or trailing edge.

It is therefore proposed that, along the leading edge and/or the trailing edge of at least some of serrated blades 90, 60, following the radial direction or span L, the serrations extend along a length H which is limited to: H/(Re-Ri)<0.8, as in the example of FIG. 5 or 7.

If necessary, length H will be cumulative over the length of the serrated areas of a same TE or LE, if there are a plurality of such areas (H1, H2, H3, etc.), as in certain exemplary figures (see in particular FIGS. 9, 19, 22).

Eighteenth consideration: One can also seek to increase the amplitude of the serrations where the turbulence length scale is larger. Indeed, several studies show that the turbulence integral scale in the wake of a rotating part increases towards the blade tip.

It is therefore proposed that the amplitude (h(r)) and/or the spacing between two successive serration tips λ(r), of at least some of the serrations in the TE and/or LE, vary monotonically, even preferably or strictly monotonically, in the direction of (or even in proximity to) free end 51 of the blade 90 and/or 60 concerned.

Nineteenth consideration: To optimize the locations of the serrations in terms of the ratio of noise reduction gains/costs/weight/resistance, the serrations 93, 63 could be located at least on at least part of trailing edge 91 of first series of blades 9 and at least part of leading edge 61 of second series of blades 6. There may thus be leading edge and trailing edge serrations on all blades at the same time. Providing them only on trailing edges 91 of first series of blades 9 and leading edge 61 of second series of blades 6 would, however, be a relevant compromise.

Twentieth consideration: The leading and/or trailing edge of blades 90 and/60 could be locally porous. One can thus ultimately provide that the leading and/or trailing edge of at least some of blades 90, 60 is formed locally by a porous material 85, at the location of at least some of the serrations. As a porous material 85, a metal foam may for example be provided, in particular at the regions with serrations 93 and/or 63, as schematically represented in FIGS. 27, 28, where λ (or λ1, λ2) corresponds to λ(r) and h (or h1, h2, h3) corresponds to h(r). In addition to enabling acoustic attenuation, porous material 85 has the effect of reducing stress concentrations due to its mechanical flexibility. This local optimization of the material's rigidity reduces the appearance of cracks under cycled loading, thus increasing the lifespan of the metal protection of the leading edge, at 61. Porous material 85 will define a portion of serrated shape 63. Thus, together, porous material 85 and the surrounding body of the blade (metal portion 73 or composite body 71, denoted 71/73 in FIGS. 27, 28) will then define serrations 63 at the LE of the blade. Porous material 85 is integrated into the blade, replacing part of metal reinforcement 73 or of composite body 71. Porous material 85 will usefully occupy the troughs or valleys 634 of serrations.

Twenty-first consideration: One can also seek to reduce the interaction of a vortex (or separation) at free end 51 of the blade.

It is therefore proposed that blades 90 or 60 of the upstream and/or downstream blade assemblies have a greater radius Re at the leading edge (LE) than at the trailing edge (TE), i.e. Re,LE>Re,TE, when the LE and TE lines are not coincident, as schematically represented in the example of FIG. 29.

The following three configurations are schematically illustrated in FIGS. 36 and 37:

Twenty-second consideration: One can also seek to reduce the interaction of a vortex (or separation) at free end 51 of the blade by reducing the load at free end 51 of blade 90 of first series of blades 9.

It is therefore proposed (as for example in FIG. 36) that blades 90 of upstream blade assembly 9 have the greatest deflection at 0.4×(Re-Ri) from free end 51, where the relative incident speeds are higher. Indeed, increasing the deflection makes it possible to reduce the incident speed perceived by the blade, which allows reducing its load and therefore the noise. In one particular embodiment, increasing the deflection near free end 51 can be achieved by defining a radius Re that is lower at the leading edge (LE) than at the trailing edge (TE), i.e. Re,LE<Re,TE, when the lines of LE and TE are not coincident. This can be combined with blades of downstream blade assembly 6 having Re,LE>Re,TE for the reasons indicated in the twenty-first consideration.

In FIG. 36, the deflection angle (indicated by the double arrows) of the blade with multiple radii.

The deflection of the blade increases near free end 51, on blade 9 taken as an example. Re,LE and Re,TE denote said radius Re, therefore between the central longitudinal axis (X) and a location on free end 51 at the leading edge and at the trailing edge of the blade, respectively.

Twenty-third consideration: One can also seek to decorrelate the sources of noise along leading edge 61 and trailing edge 91, as well as their interactions between blade assemblies 9, 6.

It is therefore proposed that trailing edge serrations 93 and leading edge serrations 63 have an amplitude (h(r)) and/or a spacing (λ(r)) which vary/varies inversely in the radial direction. towards free end 51 of the blade, as in FIG. 37.

In other words, it is proposed that
trailing edge serrations 93 on blades 90 of first series of blades 9 decrease (or increase) in amplitude h(r), and/or spacing λ(r), towards free end 51,
leading edge serrations 63 on blades 60 of second series of blades 6 increase (or decrease) in amplitude h(r), and/or spacing λ(r), towards free end 51.

Twenty-fourth consideration: To further decorrelate sources of noise and reduce interactions between blade assemblies, it is also proposed that:
towards free end 51, trailing edge serrations 93 on blades 90 of first series of blades 9 decrease in amplitude h(r), and/or in spacing λ(r), and
leading edge serrations 63 of blades 60 of second series of blades 6 increase towards free end 51 of blades 60.

Twenty-fifth consideration: One can also seek to reduce the sources of noise at the location of the maximum acoustic radiation, i.e. near free end 51.

It is therefore proposed that near the free ends of blades 90 of first series of blades 9, and blades 60 of second series of blades 6, there are trailing edge serrations 93 and leading edge serrations 63, and that these serrations begin with a tooth or tip 630, 635, not with a trough.

Concerning each blade, and at least in the intermediate portion of its span L, it will be preferable that:
its leading edge is convex, or curved to protrude upstream, or
its leading edge is concave, or curved inward downstream.

And one will also note that, among the possible configurations of blades 90 and/or 60, there can be:
some blades with a smooth leading edge over the entire span L, and with a trailing edge that is at least partly serrated, and
other blades with a smooth trailing edge over the entire span L, and with a leading edge that is at least partly serrated.

Concerning the possible variations in pitch angle Δγ, one can also refer to FIGS. 35 and 39 to 41, to confirm the following:

First, a blade, such as 6 or 9, can be considered as a stack of cross-sections or aerodynamic profiles along the direction of span L and/or in a radial (or perpendicular) direction relative to the central axis X.

Next, the pitch angle is always defined as the angle between the plane of rotation and the chord line of the profile, i.e. of the blade.

Thus, the serrations have tooth tips (630, 635) and tooth troughs (632, 634) which alternate successively one after the other on the profile considered, at the leading edge and/or at the trailing edge.

And, to ensure a favorable compromise between acoustic efficiency, stall control, and mechanical strength that cannot be further improved, it is proposed that at least some of said blades of first series of blades 9 and/or of second series of blades 6 each have, on this/these area(s) of the profile and along the span (L) of the blade or radially to the central longitudinal axis (X), a pitch angle variation (Δγ) of less than 45° in absolute value, or even 0°≤Δγ≤30° in absolute value, between:
a first straight line connecting the leading edge and the trailing edge, at a first radius where one of said tooth tips (630 or 635) is located, and
a second straight line connecting the leading edge and the trailing edge, at a second radius where one of said tooth troughs (632 or 634) is located, adjacent to said one of the tooth tips.

FIG. 39 also illustrates an example where Δγ=∥γ₆₃₄−γ₆₃₅∥, with:
γ634 which is therefore the pitch angle of the blade considered at the location of said first straight line connecting the leading edge and the trailing edge, at a first radius containing tooth trough 634,
γ635 which is therefore the pitch angle of the blade considered at the location of said first straight line connecting the leading edge and the trailing edge, at the first radius containing tooth tip 635, and,
Δγ which is therefore the pitch angle variation between angles γ634 and γ635 of the respective adjacent troughs and tips.

Furthermore, it is therefore also proposed, for the same reasons as above, that at least some of said blades of first series of blades 9 and/or of second series of blades 6 each have, along the span (L) of blade 90, 60 or radially to the central longitudinal axis (X), a pitch angle variation (Δγ) that is less in absolute value than 45°, or even 0°≤Δγ≤30° in absolute value, between:
a third straight line connecting the leading edge and the trailing edge, at a first radius where a first of said tooth tips 635 is located, and
a fourth straight line connecting the leading edge and the trailing edge, at a second radius where a second of said tooth tips 630 is located, adjacent to said first tip 635.

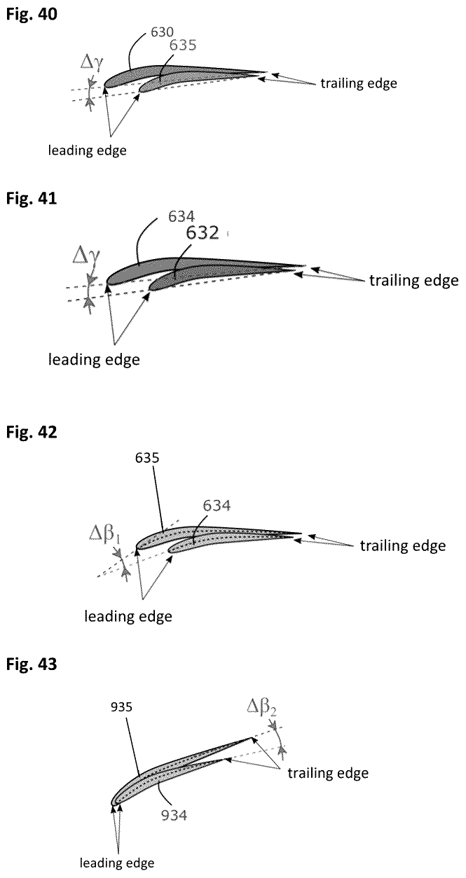

The same consideration can be applied by replacing “first of said tooth tips 635” and “second of said tooth tips 630” respectively by “first of said tooth troughs 632” and “second of said tooth troughs 634”. FIGS. 40 and 41 illustrate this, with the same areas (tips and troughs).

For each line in the groups of these first and second lines and/or third and fourth lines, a plane perpendicular to the direction of span L of the blade can be substituted.

“Adjacent” is conventionally equivalent to “successive” in the spanwise direction and/or radially relative to the central longitudinal axis (X).

Thus, as illustrated by way of example in FIG. 34:
the area of the profile at tooth tip 635 and that at tooth trough 634 are adjacent,
the area of the profile at tooth tip 630 and that at tooth trough 634 are adjacent,
the area of the profile at tooth tip 635 and that at tooth trough 632 are adjacent.

The pitch angle variation (Δγ) therefore corresponds to the difference (in absolute value) between the respective pitch angles of two of said adjacent areas mentioned above, as illustrated by way of example in FIG. 36.

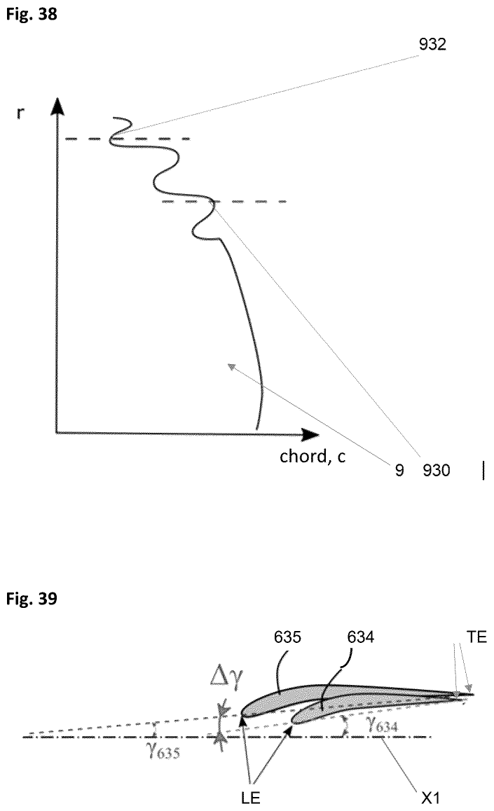

As has been understood, a profile area at the location of a trough is an area (a profile portion) obtained by a cross-section at a local chord line minimum in a region of the LE and/or TE having said serrations. A profile area at the location of a tip is an area (a profile portion) obtained by a cross-section at a local chord line maximum in a region of the LE and/or TE having said serrations; See in particular FIG. 38 where r is a radial distance on the blade, relative to the main axis X, and tips 930 and troughs 932 are areas of serrations on a blade 9 at the TE, in this example.

Further above in the description, the preferred values and their advantages, therefore with the problems that they help to (better) resolve, have also been presented for the angles Δγ, Δβ1, Δβ2. It will be useful to refer to this.

1. An aeronautical propulsion unit along which a gas flow can circulate from upstream to downstream, the propulsion unit having a central longitudinal axis (X), and comprising:
a) a first series of blades (9),
b) a second series of blades (6) positioned downstream of the first series of blades (9),
drive means (3,18,21,23,40,94,104,920) for rotating the blades of at least one among the first series of blades (9) and the second series of blades (6), about the central longitudinal axis,
c) a nacelle (5) which has an aerodynamic external surface (50) relative to which the first series of blades (9) and the second series of blades (6) project radially to the central longitudinal axis (X), each blade of the first series of blades and second series of blades having:
a free end (51) opposite to a connection end (53) forming a blade root close to the nacelle (5),
a pressure side face (55) and a suction side face (57),
a chord line C, at a radius centered on the central longitudinal axis (X),
a radius (Ri) between the central longitudinal axis (X) and a location, on the blade or a pitch arm (39,36) of the blade, which is level with the external surface (50) of the nacelle (5),
a radius (Re) between the central longitudinal axis (X) and a location, on the free end (51) of the blade, that is farthest from the central longitudinal axis (X), in a direction transverse to the central longitudinal axis (X), and
a span (L), defined, radially to the central longitudinal axis (X), between the free end (51) and the connection end (53), in said transverse direction,
at least some of the blades of the first series of blades (9) having variable pitch, such that each of them can pivot around a pitch arm (39) to which said blade is fixed, about a pitch axis (390) which passes through the blade (90), and/or
at least some of the blades of the second series of blades (6) having variable pitch, such that each of them can pivot around a pitch arm (36) to which said blade is fixed, about a pitch axis (360) which passes through the blade (60),
wherein in said propulsion unit:
at least one of the blades of the first series of blades (9) has a trailing edge (91) having serrations (93), and/or at least one of the blades of the second series of blades (6) has a leading edge (61) having serrations (63), said serrations having tooth tips (635) and tooth troughs (634) which successively alternate, and,
at least some of said blades of the first series of blades (9) and/or of the second series of blades (6) each have, along the span (L) of the blade (90, 60) or radially to the central longitudinal axis (X), a pitch angle variation (Δγ) that is less than 45°, between:
a first straight line connecting the leading edge and the trailing edge, at a first radius where one of said tooth tips (635) is located, and
a second straight line connecting the leading edge and the trailing edge, at a second radius where one of said tooth troughs (634) is located, adjacent to said one of the tooth tips (635).

2. Aeronautical propulsion unit according to claim 1, wherein the drive means comprise a gas turbine (21,23,24,96,102) for driving said rotation of the blades of the at least one of the first series of blades (9) and second series of blades (6), about the central longitudinal axis (X).

3. Aeronautical propulsion unit according to claim 1, wherein the drive means comprise a speed reducer (104) engaged with the blades of at least one of the first series of blades (9) and second series of blades (6), in order to adapt the rotation speed of said blades around the central longitudinal axis (X).

4. Aeronautical propulsion unit according to claim 1, wherein the serrations (93,63) on one of said blades have a maximum amplitude h(r) between a tip and a trough which are adjacent, h(r), such that: 0.0005×Cmax≤maximum h(r)≤0.5×Cmax, wherein Cmax is a maximum chord line of the blade and h(r) corresponds to a difference in chord line between a profile at a tip and a profile at a trough which are adjacent, along the direction of the span (L) of the blade or radially to the central longitudinal axis (X).

5. Aeronautical propulsion unit according to claim 1, wherein at least some of the blades (90,60) comprise a composite material and, on the pressure side face (55) and/or the suction side face (57), a metal reinforcement cap (73) fixed to the composite material and extending along at least part of the leading edge and/or trailing edge.

6. Aeronautical propulsion unit according to claim 5, wherein at least some of the serrations (93, 63) are formed solely on the metal reinforcement cap (73), not on the composite material.

7. Aeronautical propulsion unit according to claim 1, wherein, on at least some of the blades, the serrations have an amplitude between a tip and an adjacent trough, h(r), and a spacing between two successive serration tips, λ(r), which vary radially.

8. Aeronautical propulsion unit according to claim 7, wherein the amplitude h(r) and the spacing λ(r) of the serrations are functions defined piecewise along the span (L) of the blade (90,60).

9. Aeronautical propulsion unit according to claim 7, wherein, on at least some of the blades:
a first portion of the leading edge (61) and/or the trailing edge (91) is smooth, without serration,
a second portion of the leading edge (61) and/or the trailing edge (91) has said serrations (63,93), and
the amplitude of the serrations decreases there where the second portion is connected to the first portion, so that the connection is progressive.

10. Aeronautical propulsion unit according to claim 1, wherein the serrations (63,93) are only located towards the free end (51) of several of said blades (90,60) and/or at a radial position where the chord line is the largest, on the blade (90,60).

11. Aeronautical propulsion unit according to claim 1, wherein, along the leading edge and/or the trailing edge, the serrations extend along a cumulative length H which is limited to: H/(Re-Ri)<0.8.

12. Aeronautical propulsion unit according to claim 1, wherein the leading edge serrations (63) and/or trailing edge serrations (93) are located:
beyond 0.4×(Re-Ri), starting from the connection end (53) side, and/or
there where the chord line (C) is the largest.

13. Aeronautical propulsion unit according to claim 2, wherein the gas turbine (21,23,24,96, 102) is part of an engine (3) for driving the rotation of blades around the central longitudinal axis (X), and the first series of blades (9) and the second series of blades (6) are located towards an upstream end of the engine (3).

14. Aeronautical propulsion unit according to claim 1, wherein:
the nacelle (5) has an air inlet (35), and
on the nacelle (5), the air inlet (35) is located axially between pitch axes (390,360) of the blades of the first series of blades (9) and of the second series of blades (6).

15. Aeronautical propulsion unit according to claim 14, wherein:
on the nacelle (5), the air inlet (35) has a lip (37) located at a radius Rb from the central longitudinal axis (X), and
the trailing edge (91) of the first series of blades (9) has serrations located at said radius Rb.

16. Aeronautical propulsion unit according to claim 2, wherein the turbine (21,23,96,102) is connected to the first series of blades (9) so as to drive the rotation, around the central longitudinal axis (X), of only the blades (90) of the first series of blades (9), the blades of the second series of blades (6) defining swirl recovery vanes (60).

17. Aeronautical propulsion unit according to claim 16, wherein, circumferentially around the central longitudinal axis (X), only the swirl recovery vanes (60) located within a first angular range of +/−60° relative to 3 o'clock, and within a second angular range of +/−60° relative to 9 o'clock, have serrations (63).

18. Aeronautical propulsion unit according to claim 1 wherein the serrations (93,63) are located at least on the trailing edge (91) of the first series of blades (9) and on the leading edge (61) of the second series of blades (6).

19. Aeronautical propulsion unit according to claim 1, wherein:
the serrations (93,63) at the leading edge (61) and at the trailing edge (91) have geometries or patterns that differ from each other, and/or
the serrations (93,63) of some of the blades of the first series of blades (9) differ from the serrations (93,63) of some of the blades of the second series of blades (6) in at least one among the patterns, amplitude, spacing, and radial positioning of the serrations along the span.

20. Aeronautical propulsion unit according to claim 1, wherein at least some of the serrations (93,63) have an amplitude between a tip and an adjacent trough (h(r)) and/or a spacing between two successive serration tips (λ(r)) which vary/varies monotonically or strictly monotonically in the radial direction towards the free end (51) of the blade.

21. Aeronautical propulsion unit according to claim 20, wherein the trailing edge serrations (93) and leading edge serrations (63) have the amplitude (h(r)) and/or the spacing (λ(r)) which vary/varies respectively inversely in the radial direction towards the free end (51) of the blade.

22. Aeronautical propulsion unit according to claim 1, wherein the trailing edge serrations (93) on the blades (90) of the first series of blades (9) decrease in amplitude (h(r)) between a tip and an adjacent trough, and/or in spacing (λ(r)) between two successive serration tips, towards the free end (51), and wherein the leading edge serrations (63) of the blades (60) of the second series of blades (6) increase towards the free end (51).

23. Aeronautical propulsion unit according to claim 5, wherein the cap (73) of at least one of the blades connects the leading edge to the trailing edge, via the free end (51) of the blade.

24. Aeronautical propulsion unit according to claim 1, wherein the free end (51) of at least one of the blades (90,60):
is of elliptical shape (79) or rounded shape (80), and/or
has an abrupt change in a slope angle (77).

25. Aeronautical propulsion unit according to claim 1, wherein the leading and/or trailing edge of at least some of the blades (90,60) is formed locally by a porous material (85), at the location of at least some of the serrations.

26. Aeronautical propulsion unit according to claim 1, wherein, on a leading edge (61) or trailing edge (91) area of a blade having serrations (63,93), a variation of skeleton angle (Δβ1) at the leading edge or (Δβ2) at the trailing edge, between a tooth tip (635) and a tooth trough (634), adjacent to one another,
along the span (L) of the blade (90,60), or
radially to the central longitudinal axis (X), is less than 45°.

27. Aeronautical propulsion unit according to claim 1 wherein, on a leading edge (61) or trailing edge (91) area of a blade having serrations (63,93), a variation in skeleton angle (Δβ1) at the leading edge or (Δβ2) at the trailing edge, between two tooth tips (630,631) adjacent to one another and/or two tooth troughs (632,634) adjacent to one another,
along the span (L) of the blade (90,60), or
radially to the central longitudinal axis (X), is less than 45°.

28. Aeronautical propulsion unit according to claim 1, wherein at least some of said blades of the first series of blades (9) and/or of the second series of blades (6) each have, along the span (L) of the blade (90,60) or radially to the central longitudinal axis (X), a pitch angle variation (Δγ) that is less than 45°, between:
a third straight line connecting the leading edge and the trailing edge, at a first radius where a first of said tooth tips (635) is located, and
a fourth straight line connecting the leading edge and the trailing edge, at a second radius where a second of said tooth tips (635) is located, adjacent to said first tip.

29. Aeronautical propulsion unit according to claim 1, wherein at least one of the blades (90,60) of one of the series of blades (9,6) has the greatest deflection at a radial position located over a radial length of 0.4×(Re-Ri) from the free end (51).

30. Aeronautical propulsion unit according to claim 1, wherein at least one of the blades (60) of the second series of blades (6) has a radius (Re) that is larger at the leading edge (LE) than at the trailing edge (TE), when the leading edge and trailing edge lines are not coincident, and wherein at least one of the blades (90) of the first series of blades has a radius Re that is smaller or larger at the leading edge (LE) than at the trailing edge (TE), when the leading edge and trailing edge lines are not coincident.

31. An aeronautical propulsion unit along which a gas flow can circulate from upstream to downstream, the propulsion unit having a central longitudinal axis (X), and comprising:
a) a first series of blades (9),
b) a second series of blades (6) positioned downstream of the first series of blades (9),
drive means (3,18,21,23,40,94,104,920) for rotating the blades of at least one among the first series of blades (9) and the second series of blades (6), about the central longitudinal axis,
c) a nacelle (5) which has an aerodynamic external surface (50) relative to which the first series of blades (9) and the second series of blades (6) project radially to the central longitudinal axis (X), each blade of the first series of blades and second series of blades having:
a free end (51) opposite to a connection end (53) forming a blade root close to the nacelle (5),
a pressure side face (55) and a suction side face (57),
a chord line C, at a radius centered on the central longitudinal axis (X),
a radius (Ri) between the central longitudinal axis (X) and a location, on the blade or a pitch arm (39,36) of the blade, which is level with the external surface (50) of the nacelle (5),
a radius (Re) between the central longitudinal axis (X) and a location, on the free end (51) of the blade, that is farthest from the central longitudinal axis (X), in a direction transverse to the central longitudinal axis (X), and
a span (L), defined, radially to the central longitudinal axis (X), between the free end (51) and the connection end (53), in said transverse direction,
at least some of the blades of the first series of blades (9) having variable pitch, such that each of them can pivot around a pitch arm (39) to which said blade is fixed, about a pitch axis (390) which passes through the blade (90), and/or
at least some of the blades of the second series of blades (6) having variable pitch, such that each of them can pivot around a pitch arm (36) to which said blade is fixed, about a pitch axis (360) which passes through the blade (60),
wherein in said propulsion unit:
at least one of the blades of the first series of blades (9) has a trailing edge (91) having serrations (93), and/or at least one of the blades of the second series of blades (6) has a leading edge (61) having serrations (63), said serrations having tooth tips (635) and tooth troughs (634) which successively alternate,
at least some of said blades of the first series of blades (9) and/or of the second series of blades (6) each have, along the span (L) of the blade (90, 60) or radially to the central longitudinal axis (X), a pitch angle variation (Δγ) that is less than 45°, between:
a first straight line connecting the leading edge and the trailing edge, at a first radius where one of said tooth tips (635) is located, and
a second straight line connecting the leading edge and the trailing edge, at a second radius where one of said tooth troughs (634) is located, adjacent to said one of the tooth tips (635),
wherein the drive means comprise a gas turbine (21,23,24,96,102) for driving said rotation of the blades of the at least one of the first series of blades (9) and second series of blades (6), about the central longitudinal axis (X),
wherein the gas turbine (21,23,24,96,102) is part of an engine (3) for driving the rotation of blades around the central longitudinal axis (X), and the first series of blades (9) and the second series of blades (6) are located towards an upstream end of the engine (3), and
the nacelle (5) has an air inlet (35),
on the nacelle (5), the air inlet (35) is located axially between pitch axes (390,360) of the blades of the first series of blades (9) and of the second series of blades (6),
on the nacelle (5), the air inlet (35) has a lip (37) located at a radius Rb from the central longitudinal axis (X), and
the trailing edge (91) of the first series of blades (9) has serrations located at said radius Rb.

32. An aeronautical propulsion unit along which a gas flow can circulate from upstream to downstream, the propulsion unit having a central longitudinal axis (X), and comprising:
a) a first series of blades (9),
b) a second series of blades (6) positioned downstream of the first series of blades (9),
drive means (3,18,21,23,40,94,104,920) for rotating the blades of at least one among the first series of blades (9) and the second series of blades (6), about the central longitudinal axis,
c) a nacelle (5) which has an aerodynamic external surface (50) relative to which the first series of blades (9) and the second series of blades (6) project radially to the central longitudinal axis (X), each blade of the first series of blades and second series of blades having:
a free end (51) opposite to a connection end (53) forming a blade root close to the nacelle (5),
a pressure side face (55) and a suction side face (57),
a chord line C, at a radius centered on the central longitudinal axis (X),
a radius (Ri) between the central longitudinal axis (X) and a location, on the blade or a pitch arm (39,36) of the blade, which is level with the external surface (50) of the nacelle (5),
a radius (Re) between the central longitudinal axis (X) and a location, on the free end (51) of the blade, that is farthest from the central longitudinal axis (X), in a direction transverse to the central longitudinal axis (X), and
a span (L), defined, radially to the central longitudinal axis (X), between the free end (51) and the connection end (53), in said transverse direction,
at least some of the blades of the first series of blades (9) having variable pitch, such that each of them can pivot around a pitch arm (39) to which said blade is fixed, about a pitch axis (390) which passes through the blade (90), and/or
at least some of the blades of the second series of blades (6) having variable pitch, such that each of them can pivot around a pitch arm (36) to which said blade is fixed, about a pitch axis (360) which passes through the blade (60),
wherein in said propulsion unit:
at least one of the blades of the first series of blades (9) has a trailing edge (91) having serrations (93), and/or at least one of the blades of the second series of blades (6) has a leading edge (61) having serrations (63), said serrations having tooth tips (635) and tooth troughs (634) which successively alternate,
at least some of said blades of the first series of blades (9) and/or of the second series of blades (6) each have, along the span (L) of the blade (90, 60) or radially to the central longitudinal axis (X), a pitch angle variation (Δγ) that is less than 45°, between:
a first straight line connecting the leading edge and the trailing edge, at a first radius where one of said tooth tips (635) is located, and
a second straight line connecting the leading edge and the trailing edge, at a second radius where one of said tooth troughs (634) is located, adjacent to said one of the tooth tips (635),
wherein the drive means comprise a gas turbine (21,23,24,96,102) for driving said rotation of the blades of the at least one of the first series of blades (9) and second series of blades (6), about the central longitudinal axis (X), and
wherein the turbine (21,23,96,102) is connected to the first series of blades (9) so as to drive the rotation, around the central longitudinal axis (X), of only the blades (90) of the first series of blades (9), the blades of the second series of blades (6) defining swirl recovery vanes (60).

33. An aeronautical propulsion unit along which a gas flow can circulate from upstream to downstream, the propulsion unit having a central longitudinal axis (X), and comprising:
a) a first series of blades (9),
b) a second series of blades (6) positioned downstream of the first series of blades (9),
drive means (3,18,21,23,40,94,104,920) for rotating the blades of at least one among the first series of blades (9) and the second series of blades (6), about the central longitudinal axis,
c) a nacelle (5) which has an aerodynamic external surface (50) relative to which the first series of blades (9) and the second series of blades (6) project radially to the central longitudinal axis (X), each blade of the first series of blades and second series of blades having:
a free end (51) opposite to a connection end (53) forming a blade root close to the nacelle (5),
a pressure side face (55) and a suction side face (57),
a chord line C, at a radius centered on the central longitudinal axis (X),
a radius (Ri) between the central longitudinal axis (X) and a location, on the blade or a pitch arm (39,36) of the blade, which is level with the external surface (50) of the nacelle (5),
a radius (Re) between the central longitudinal axis (X) and a location, on the free end (51) of the blade, that is farthest from the central longitudinal axis (X), in a direction transverse to the central longitudinal axis (X), and
a span (L), defined, radially to the central longitudinal axis (X), between the free end (51) and the connection end (53), in said transverse direction,
at least some of the blades of the first series of blades (9) having variable pitch, such that each of them can pivot around a pitch arm (39) to which said blade is fixed, about a pitch axis (390) which passes through the blade (90), and/or
at least some of the blades of the second series of blades (6) having variable pitch, such that each of them can pivot around a pitch arm (36) to which said blade is fixed, about a pitch axis (360) which passes through the blade (60),
wherein in said propulsion unit:
at least one of the blades of the first series of blades (9) has a trailing edge (91) having serrations (93), and/or at least one of the blades of the second series of blades (6) has a leading edge (61) having serrations (63), said serrations having tooth tips (635) and tooth troughs (634) which successively alternate, and,
at least some of said blades of the first series of blades (9) and/or of the second series of blades (6) each have, along the span (L) of the blade (90, 60) or radially to the central longitudinal axis (X), a pitch angle variation (Δγ) that is less than 45°, between:
a first straight line connecting the leading edge and the trailing edge, at a first radius where one of said tooth tips (635) is located, and
a second straight line connecting the leading edge and the trailing edge, at a second radius where one of said tooth troughs (634) is located, adjacent to said one of the tooth tips (635), and
wherein at least one of the blades (90,60) of one of the series of blades (9,6) has the greatest deflection at a radial position located over a radial length of 0.4×(Re-Ri) from the free end (51).
